(19) United States
(12) Patent Application Publication
(10) Pub. No.: US 2026/0254645 A1
(43) Pub. Date: Aug. 27, 2026

(54) PQC ADAPTATION FOR 6G AKA PROCEDURE

(71) Applicant: Nokia Technologies Oy, Espoo (FI)

(72) Inventors: Ranganathan MAVUREDDI DHANASEKARAN, Munich (DE); Aritra BANERJEE, Cambridge (GB); K TIRUMALESWAR REDDY, Bangalore (IN); Saurabh KHARE, Bangalore (IN)

(21) Appl. No.: 19/412,038

(22) Filed: Dec. 8, 2025

Related U.S. Application Data
(60) Provisional application No. 63/736,981, filed on Dec. 20, 2024.

(51) Int. Cl. H04L 9/32; H04L 9/08; H04W 12/069

(52) U.S. Cl. CPC H04L 9/3213; H04L 9/0852; H04W 12/069

(57) ABSTRACT

The present disclosure relates to post quantum cryptography (PQC) enhancement of authentication and key agreement (AKA) procedures for use in communication networks. Aspects of the disclosure include use of a pre-shared post quantum key (PPK), or a selected PPK from a list of PPKs, or use of a home network public key (pk) and private key (sk) derived using a post-quantum cryptography (PQC) key generation function, defining PQC-based pk and sk, for authentication procedures between user equipment and a network entity. Aspects of the disclosure further include use of the PQC-based pk and sk for key generation of shared PQC-based keys.

### FIELD

The present disclosure relates generally to communication networks and, more specifically, to post quantum cryptography (PQC) enhancement of authentication and key agreement (AKA) procedures for use in communication networks.

### BACKGROUND

A mobile telecommunication network or cellular network (generally referred to herein as a communication network) enables communications between two or more communication devices, provides communication devices access to a data network, delivers services provided by third-party applications to communication devices, or provides services offered by the communication network to communication devices.

A communication network and communication devices may operate in accordance with cellular technologies (otherwise referred to as radio access technologies), such as GSM, UMTS, LTE, LTE-A and NR. Cellular technologies are standardized by various standards organizations, such as the Third Generation Partnership Project (3GPP) or ETSI (European Telecommunications Standards Institute). 3GPP is currently developing standards for 5^{th} generation cellular technologies (generally referred to as 5G or NR standards) and 6^{th} generation cellular technologies (generally referred to as 6G standards). Communication networks that operate in accordance with 5G or NR standards are generally referred to as 5G networks and communication networks that operate in accordance with 6G standards are generally referred to as 6G networks.

A communication network (e.g., a 5G network or a 6G network) includes access networks (e.g., radio access networks) that can communicate wirelessly with one or multiple communication devices by sharing available resources (e.g., bandwidth, transmit power, etc.) of the access network (e.g., radio access network). A communication network can also establish reliable, secure connectivity between communication devices and a core network of the communication network via access networks. A communication network (e.g., a 5G network or a 6G network) may provide enhanced mobile broadband services (e.g., telephony, video, data, short message services), ultra-reliable low-latency communication services (e.g., XR services), or massive machine type communication services to communication devices.

Authentication and key agreement (AKA) procedures are a security mechanism used within communication networks (e.g., 5G network or 6G networks). In one aspect, AKA procedures enable mutual authentication between a user equipment (UE) and a core network of the communication network; and provide keying material that can be used between the UE and a serving network in subsequent security procedures.

Enhancements of AKA procedures are desirable.

### SUMMARY

The present disclosure relates to post quantum cryptography (PQC) enhancement of authentication and key agreement (AKA) procedures for use in communication networks.

In a first aspect of the present disclosure, there is provided an apparatus comprising: at least one processor; and at least one memory storing instructions that, when executed by the at least one processor, cause the apparatus at least to: obtain a pre-shared post quantum key (PPK); initiate a registration with a home network indicating use of the PPK; receive, from a network entity, an authentication challenge including an authentication token (AUTN PPK) and a PPK indication, wherein AUTN PPK is derived in part using the PPK; and verify the authentication token in part using the PPK.

In a second aspect of the present disclosure, there is provided an apparatus comprising: at least one processor; and at least one memory storing instructions that, when executed by the at least one processor, cause the apparatus at least to: obtain a list of pre-shared post quantum keys (PPK); initiate a registration with a home network indicating use of the PPK; receive, from a network entity, an authentication challenge including an authentication token (AUTN PPK) and a PPK indication identifying a selected PPK from the list of PPKs, wherein AUTN PPK is derived in part using the selected PPK; and verify the authentication token in part using the selected PPK.

In a third aspect of the present disclosure, there is provided an apparatus comprising: at least one processor; and at least one memory storing instructions that, when executed by the at least one processor, cause the apparatus at least to: obtain a pre-shared post quantum key (PPK); initiate a registration with a home network indicating use of the PPK; receive, from a network entity, an authentication challenge including an authentication token (AUTN PPK) and a PPK indication; verify the authentication token; compute an enhanced response (RES*) indicating successful verification, wherein RES* is derived in part using the PPK; and send the enhanced response (RES*) to the network entity.

In a fourth aspect of the present disclosure, there is provided an apparatus comprising: at least one processor; and at least one memory storing instructions that, when executed by the at least one processor, cause the apparatus at least to: obtain a list of pre-shared post quantum keys (PPKs); initiate a registration with a home network indicating use of the PPK; receive, from a network entity, an authentication challenge including an authentication token (AUTN PPK) and a PPK indication identifying a selected PPK from the list of PPKs; verify the authentication token; compute an enhanced response (RES*) indicating successful verification, wherein RES* is derived in part using the selected PPK; and send the enhanced response (RES*) to the network entity.

In a fifth aspect of the present disclosure, there is provided an apparatus comprising: at least one processor; and at least one memory storing instructions that, when executed by the at least one processor, cause the apparatus at least to: generate a home network public key (pk) and private key (sk) derived using a post-quantum cryptography (PQC) key generation function, defining a PQC-based pk and sk; initiate a registration with a home network using the PQC-based pk; receive, from a network entity, an authentication challenge including an authentication token with cipher text (AUTN with cipher text (ct)), wherein AUTN with ct includes ct and AUTN with ct is derived in part using the PQC-based pk; and verify the authentication token in part using the PQC-based sk.

In a sixth aspect of the present disclosure, there is provided an apparatus comprising: at least one processor; and at least one memory storing instructions that, when executed by the at least one processor, cause the apparatus at least to: generate a home network public key (pk) and private key (sk) derived using a post-quantum cryptography (PQC) key generation function, defining a PQC-based pk and sk; prepare a PQC bitmap indicating one or more network entities that support PQC; initiate a registration with a home network using the PQC-based pk and including the PQC bitmap; receive from a network entity, a security mode command message (SMC) including a ciphertext (ct) and a PQC indication, the SMC defining a PQC SMC; generate a shared secret (pqc_ss) using the ct and the sk; derive a value (pqc_ct) by concatenating pqc_ss with ct; and derive a shared PQC key associated with the network entity by concatenating pqc_ct with a non-PQC key of the network entity.

In a seventh aspect of the present disclosure, there is provided an apparatus comprising: at least one processor; and at least one memory storing instructions that, when executed by the at least one processor, cause the apparatus at least to: generate a home network public key (pk) and private key (sk) derived using a post-quantum cryptography (PQC) key generation function, defining a PQC-based pk and sk; prepare a PQC bitmap indicating one or more network entities that support PQC; initiate a registration with a home network using the PQC-based pk and including the PQC bitmap; receive from an access and mobility management function (AMF), a non-access stratum (NAS) security mode command message (SMC) including a ciphertext (ct) and a PQC indication, the SMC defining a PQC SMC; generate a shared secret (pqc_ss) using the ct and the sk; derive a value (pqc_ct) by concatenating pqc_ss with ct; and derive an AMF PQC key (KAMF_PQC) by concatenating pqc_ct with an AMF non-PQC key (KAMF).

In an eighth aspect of the present disclosure, there is provided an apparatus comprising: at least one processor; and at least one memory storing instructions that, when executed by the at least one processor, cause the apparatus at least to: generate a home network public key (pk) and private key (sk) derived using a post-quantum cryptography (PQC) key generation function, defining a PQC-based pk and sk; prepare a PQC bitmap indicating one or more network entities that support PQC; initiate a registration with a home network using the PQC-based pk and including the PQC bitmap; receive from a base station (gNB) of a radio access network (RAN), an access stratum (AS) security mode command message (SMC) including a ciphertext (ct) and a PQC indication, the SMC defining a PQC SMC; generate a shared secret (pqc_ss) using the ct and the sk; derive a value (pqc_ct) by concatenating pqc_ss with ct; and derive a gNB PQC key (KgNB_PQC) by concatenating pqc_ct with a gNB non-PQC key (KgNB).

In accordance with aspects of the present disclosure, an apparatus includes at least one processor and at least one memory storing instructions. The instructions, when executed by the at least one processor, cause the apparatus to perform any of the methods and aspects described above.

In accordance with aspects of the present disclosure, a processor readable medium stores instructions which, when executed by at least one processor of an apparatus, cause the apparatus to perform any of the methods and aspects described above.

According to some aspects, there is provided the subject matter of the independent claims. Some further aspects are defined in the dependent claims.

The above summary provides a basic understanding of some aspects of the present disclosure. This summary is not an extensive overview of the present disclosure. Nor is it intended to be used to limit the scope of the present disclosure. Other aspects and features of the present disclosure will become apparent to those of ordinary skill in the art upon review of the following description of example embodiments in conjunction with the accompanying figures.

### BRIEF DESCRIPTION OF THE DRAWINGS

Some example embodiments will now be described with reference to the accompanying drawings.

FIG. 1 is a schematic representation of a communication system in accordance with an example implementation;

FIG. 2 illustrates user equipment and network entities of a communication system in accordance with an example implementation;

FIGS. 3A-3B are a message sequence and operations diagram for an existing authentication and key agreement (AKA) procedure;

FIGS. 4A-4B are a message sequence and operations diagram for an AKA procedure using Post-Quantum Pre-Shared Keys (PPK) in accordance with a first example implementation;

FIG. 5A-5B are a message sequence and operations diagram for an AKA procedure using PPK in accordance with a second example implementation;

FIG. 6A-6B are a message sequence and operations diagram for an AKA procedure without PPK in accordance with an example implementation;

FIG. 7 shows construction of an authentication vector (AV) for use in the AKA procedure of FIG. 4A-4B or FIGS. 5A-5B in accordance with example implementations;

FIG. 8A-8B are a message sequence and operations diagram for an AKA procedure using Post-Quantum Cryptography (PQC) in accordance with a first example implementation;

FIG. 9 shows construction of an authentication token (AUTN) for use in the AKA procedure of FIGS. 8A-8B;

FIGS. 10A-10B are a message sequence and operations diagram for an AKA procedure using PQC in accordance with a second example implementation;

FIGS. 11A-11B are a message sequence and operations diagram for an AKA procedure using PQC in accordance with a third example implementation;

FIG. 12A-12B are a message sequence and operations diagram for an AKA procedure using PQC in accordance with a fourth example implementation;

FIG. 13 shows a PQC bitmap for use in the AKA procedure of FIGS. 10A-10B, 11A-11B or 12A-12B in accordance with example implementations;

FIG. 14 shows construction of an encryption key (KAMF_PQC) for use in the AKA procedure of FIGS. 10A-10B or FIGS. 11A-11B in accordance with example implementations;

FIG. 15 shows construction of an encryption key (Kgnb_PQC) for use in the AKA procedure of FIGS. 12A-12B in accordance with an example implementation.

### DETAILED DESCRIPTION

The subject matter is described herein with reference to the accompanying drawings, in which example implementations are shown. However, many different example implementations may be used, and thus the description should not be construed as limited to the embodiments set forth herein. Rather, these example embodiments are provided so that this application will be thorough and complete. Wherever possible, the same reference numbers are used in the drawings and the following description to refer to the same elements. Separate boxes or illustrated separation of logical elements of illustrated systems and devices does not necessarily require physical separation of such logical elements, as communication between such logical elements may occur by way of messaging, function calls, shared memory space, and so on, without any such physical separation. As such, logical elements need not be implemented in physically or logically separated platforms, although such logical elements are illustrated separately for ease of explanation herein. Different devices may have different designs, such that although some devices implement some logical elements in hardware, other devices may implement such logical elements in a programmable processor with code obtained from a machine-readable medium. Lastly, elements referred to in the singular may be plural and vice versa, except where indicated otherwise either explicitly or inherently by context.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described.

As used herein, the terms “send to,” “send towards,” “receive from,” “communicate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

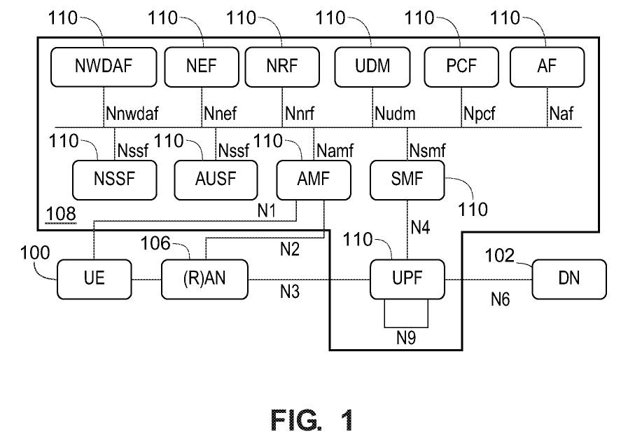

Prior to describing illustrative embodiments, a general description of a communication system will be described below in the context of FIG. 1.

Referring to FIG. 1, user equipment (UE) 100 that communicates with application servers (not shown) hosting third party application functions (not shown) of a data network 102 via a core network 108 is shown. The communication system includes a radio access network 106 (e.g., a Next Generation Radio Access Network (NG-RAN)) and a core network 108 (e.g., a 5G core network (5GC)) that operates based on 5^{th} generation radio access technology described, for example, in the 3^{rd} Generation Partnership Project (3GPP) standard for new radio. The core network 108 includes various network entities 110 (commonly referred to as network functions) described in further detail below.

The user equipment 100 may be any device capable of sending and receiving radio signals. Non-limiting examples of user equipment include a mobile station (MS), a mobile device such as a mobile phone, or what is known as a “smart phone,” a computer provided with a wireless interface card or other wireless interface facility (e.g., USB dongle), a personal data assistant (PDA) or a tablet provided with wireless communication capabilities, a machine-type communication (MTC) device, and Internet of Things (IoT) type communication device or any combination of these.

Radio access network 106 comprises one or more radio access network (RAN) nodes (otherwise referred to as base stations). A RAN node may provide one or more cells. A cell may be, for example, a macro cell, a micro cell, femto, or a pico cell. A cell defines a coverage area or a service area of a RAN node. A RAN node may be, for example, a node B (NodeB or NB), an evolved NodeB (eNodeB or eNB), a next generation node B (gNodeB or gNB), a Remote Radio Unit (RRU), a remote radio head (RRH), a relay, an Integrated Access and Backhaul (IAB) node, or a low power node.

The core network 108 has a service-based architecture. The network functions 110 of the core network include an access and mobility management function (AMF), an authentication server function (AUSF), a network exposure function (NEF), a network repository function (NRF), a network slicing selection function (NSSF), a policy control function (PCF), a session management function (SMF), a user plane function (UPF), a united data Management (UDM), and a network data analytics function (NWDAF).

The AMF handles access, authorization and authentication of the UE 100 and manages the mobility of the UE 100 as the UE moves between different radio access networks, cells or locations.

The AUSF performs authentication and security-related functions to ensure secure and authenticated communication between the UE and the core network (CN). The AUSF is an intermediate node between the AMF and the UDM in a 5G or 6G AKA procedure.

The UDM performs authentication procedures, stores and manages user data, including subscriber profiles, authentication credentials, and authorization policies, implements security mechanisms to protect user data and resources of the communication network (e.g., the core network 108) from unauthorized attacks and vulnerabilities. The UDM is also responsible for managing the registration of network functions that serve the UE 100.

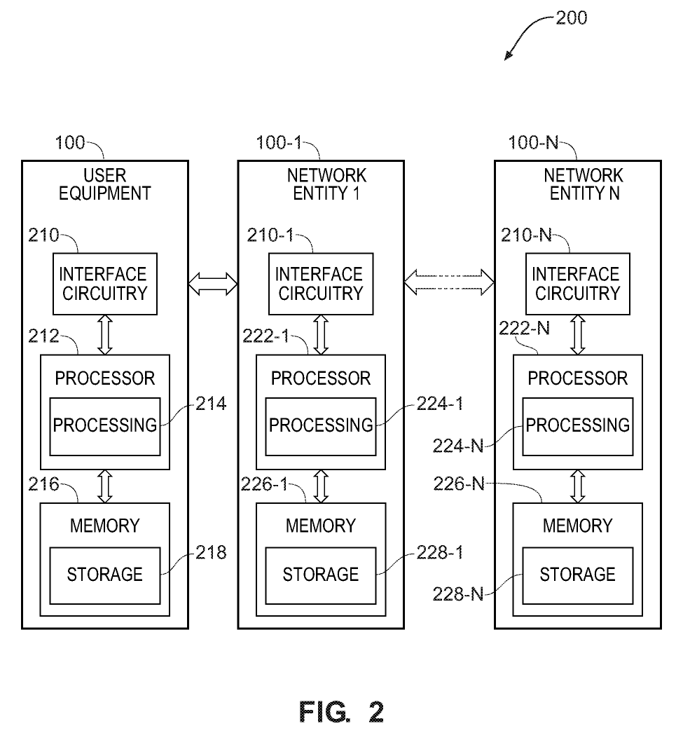

FIG. 2 is a block diagram illustrating user equipment and network entities of a core network 108 according to illustrative embodiments. More particularly, system 200 is shown comprising user equipment (UE) 100 and a plurality of network entities 110-1, . . . . , 110-N. For example, in illustrative embodiments, network entities 110-1, . . . , 110-N can include an AMF, AUSF and UDM. It is to be appreciated that the UE 100 and the network entities 110-1, . . . . , 110-N comprising an AMF, AUSF and UDM are configured to interact to perform security operations, including Authentication and Key Agreement (AKA) procedures that enable mutual authentication between the UE 100 and the core network 108 of the communication system; and provide keying material that can be used between the UE and a serving network for establishing secure communication channels and ensuring data confidentiality and integrity.

The user equipment 100 comprises a processor 212 coupled to a memory 216 and interface circuitry 210. The processor 212 of the user equipment 100 includes a processing module 214 that may be implemented at least in part in the form of software executed by the processor. The processing module 214 performs security operations described in conjunction with figures and example embodiments described herein. The memory 216 of the user equipment 100 includes a storage module 218 that stores instructions and data generated or otherwise used during security operations.

Although not shown in FIG. 2, the UE includes Mobile Equipment (ME) and a USIM. Both the ME and USIM may be considered to include a processor 212 coupled to a memory 216 and interface circuitry 210, such as described generally in relation to the UE.

Each of the network entities (individually or collectively referred to herein as 110) comprises a processor 222 (222-1, . . . , 222-N) coupled to a memory 226 (226-1, . . . , 226-N) and interface circuitry 220 (220-1, . . . , 220-N). Each processor 222 of each network entity 110 includes a processing module 224 (224-1, . . . , 224-N) that may be implemented at least in part in the form of software executed by the processor 222. The processing module 224 performs security operations described in conjunction with figures and example embodiments described herein. Each memory 226 of each network entity 110 includes a storage module 228 (228-1, . . . , 228-N) that stores instructions and/or data generated or otherwise used during security operations.

The processors 212 and 222 may comprise, for example, microprocessors such as central processing units (CPUs), application-specific integrated circuits (ASICs), digital signal processors (DSPs) or other types of processing devices, as well as portions or combinations of such elements.

The memories 216 and 226 may be used to store one or more software programs that are executed by the respective processors 212 and 222 to implement at least a portion of the functionality described herein. For example, security operations and other functionality as described in conjunction with figures and example embodiments herein may be implemented in a straightforward manner using software code executed by processors 212 and 222.

The memories 216 and 226 may be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

Further, the memories 216 and 226 may more particularly comprise, for example, electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 illustratively comprise transceivers or other communication hardware or firmware that allows the associated system elements to communicate with one another.

It is apparent from FIG. 2 that user equipment 100 and the plurality of network entities 110 are configured to interact for security operations via their respective interface circuitries 210 and 220. This communication involves each participant sending data to and/or receiving data from one or more of the other participants. The term “data” as used herein is intended to be construed broadly, so as to encompass any type of information that may be sent between participants including, but not limited to, identity data, key pairs, key indicators, tokens, secrets, security management messages, registration request/response messages and data, request/response messages, authentication request/response messages and data, metadata, control data, audio, video, multimedia, consent data, other messages, etc.

It is to be appreciated that the particular arrangement of components shown in FIG. 2 is an example only, and numerous alternative configurations may be used in other embodiments. For example, any given network element/function can be configured to incorporate additional or alternative components and to support other communication protocols.

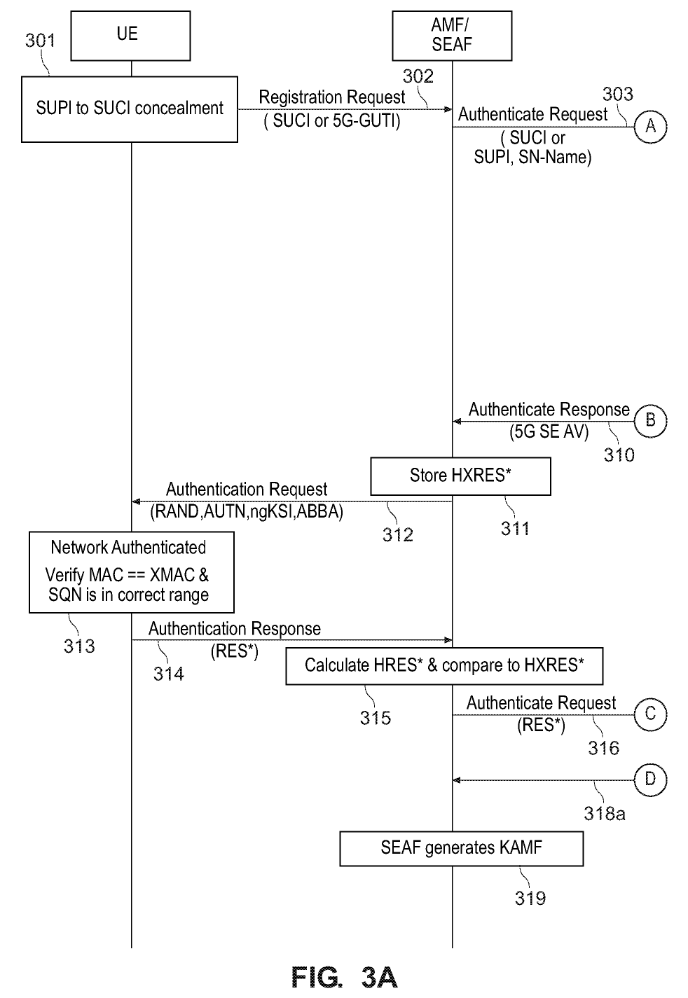

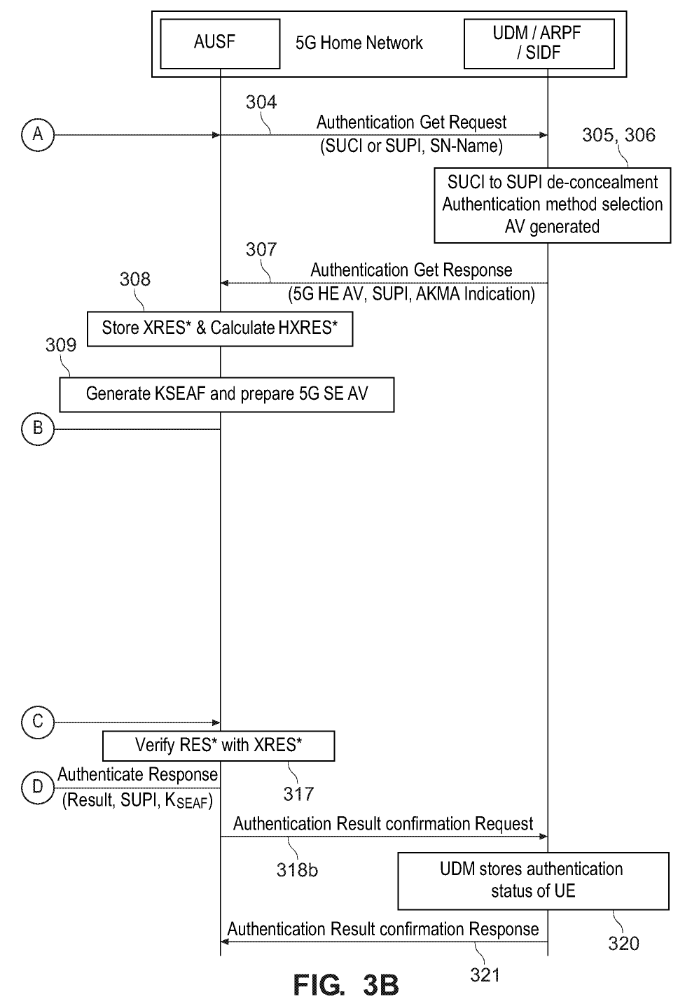

FIGS. 3A-3B are a message sequence and operations diagram that illustrates an existing 5G AKA procedure, such as described in 3GPP TS 33.501 (v18.2.0), which is incorporated by reference as if fully included herein.

### UE initiating a registration procedure

At operation 301, the UE performs SUPI to SUCI concealment. The SUPI (Subscription Permanent Identifier) is a globally unique 5G identifier allocated to each subscriber in the 5G system 100. The SUCI (Subscription Concealed Identifier) contains the concealed Subscription Permanent Identifier (SUPI). The SUCI is composed of a SUPI type, a Home Network Identifier (HN-ID) identifying the home network of the subscriber, a Routing Indicator (RID) that is assigned to the subscriber by the home network operator and provisioned in the Universal Subscriber Identity Module (USIM) of the UE 106, a Protection Scheme Identifier, a Home Network Public Key Identifier, and a Scheme Output (containing ECC Ephemeral Public Key, cipher text value and MAC tag value).

At operation 302, the UE transmits a Registration Request to the AMF. The AMF includes a Security Anchor Function (SEAF) that supports authentication functionality. The UE includes the SUCI or a 5G Global Unique Temporary Identifier (5G-GUTI) in the Registration Request.

At operation 303, the SEAF sends an Authenticate Request to the AUSF to initiate an authentication. The Authenticate Request includes the SUCI or SUPI, and the serving network name (SN-Name).

At operation 304, upon receiving the Authenticate Request, the AUSF checks that the requesting SEAF in the serving network is entitled to use the serving network name (SN-Name) in the Authenticate Request by comparing the serving network name with the expected serving network name. If authorized, the AUSF sends an Authentication Get Request to the UDM of the home network. The Authentication Get Request includes the SUCI or SUPI, and the serving network name.

At operation 305, upon reception of the Authentication Get Request, the UDM identifies the SUPI (if received), or invokes a Subscription Identifier De-concealing Function (SIDF) that de-conceals the SUPI from the SUCI (if received). The UDM (or an Authentication credential Repository and Processing Function (ARPF) of UDM) selects or chooses the authentication method for primary authentication based on the SUPI.

### Home network computes an AKA challenge

At operation 306, the UDM using cryptographic functions (f1, f2, f3, f4, f5), computes a message authentication code (MAC), expected response (XRES), a cipher key (CK), an integrity key (IK) and an anonymity key (AK), with inputs including Long term key (K), a generated new random number (RAND), an authentication and key management field AMF and a freshly generated sequence number (SQN) (created by incrementing a stored non time based SQN or time based SQN generation of partial time based SQN generation). The UDM, using key derivative functions (KDF), derives a K_{AUSF} key and calculates an expected enhanced response (XRES*) to a challenge. The K_{AUSF} key is derived from a KDF with inputs including the concatenation of CK and IK (CK||IK), serving network name (SNN) and “XOR” of Sequence Number (SQN) of Home network and Anonymity Key AK. XRES* is derived from a KDF with inputs including RAND, XRES, CK||IK and SNN. The UDM then creates a 5G Home Environment Authentication Vector (5G HE AV) containing RAND, an authentication token (AUTN), XRES* and K_{AUSF}.

At operation 307, the UDM sends an Authentication Get Response to the AUSF with the 5G HE AV, SUPI and an Authentication and Key Management for Application (AKMA) indication.

At operation 308, the AUSF stores the expected enhanced response (XRES*) temporarily with the received SUCI or SUPI. The AUSF then calculates a hash expected enhanced response (HXRES*) from the expected enhanced response (XRES*) by using the SHA-256 algorithm with the concatenated inputs RAND and XRES*.

At operation 309, the AUSF generates the K_{SEAF} key from the K_{AUSF} key, and prepares a 5G Serving Environment Authentication Vector (5G SE AV). The 5G SE AV includes RAND, AUTN and a hash expected response (HXRES*).

At operation 310, the AUSF sends an Authenticate Response to the SEAF that includes the 5G SE AV.

At operation 311, the SEAF stores the HXRES*.

At operation 312, the SEAF sends an Authentication Request to the UE. The Authentication Request includes RAND, AUTN, a next-generation key set identifier (ngKSI) and an Anti-Bidding down Between Architectures (ABBA) parameter.

### Network authenticated by the UE

The UE includes Mobile Equipment (ME) and a USIM. The ME receives the authentication token (AUTN) and the random challenge (RAND) in the Authentication Request, and forwards the authentication token (AUTN) and the random challenge (RAND) to the USIM. At operation 313, the USIM verifies the integrity of the authentication token (AUTN) by retrieving the MAC from the authentication token, computing an XMAC using cryptographic functions corresponding to that used by the UDM, and verifies AUTN integrity if MAC = XMAC. USIM also verifies if the SQN of Home network received (called SQNHN), is within the correct range and if so, it will replace it in SQN in USIM (called SQNMS). If AUTN integrity is verified, the USIM computes a response (RES).

The USIM also computes CK and IK, and returns the response (RES), the CK key, and the IK key to the ME. The ME then computes RES* from RES, calculates the K_{AUSF} key, and calculates the K_{SEAF} key from the K_{AUSF} key. The K_{AUSF} key is derived from a KDF with inputs including the concatenation of CK and IK (CK||IK), serving network name (SNN) and “XOR” of Sequence Number (SQN) and Anonymity Key AK. Enhanced response RES* is derived from a KDF with inputs including RAND, RES, CK||IK and SNN.

At operation 314, the UE sends an Authentication Response to the SEAF that includes RES*.

### UE authenticated by the serving network

At operation 315, the SEAF computes a hash of the enhanced response HRES* using the SHA-256 hashing algorithm from the received response RES*, and compares HRES* with the expected enhanced hash value HXRES*. If the compared values are equal, SEAF considers the authentication successful from the serving network point of view.

At operation 316, the SEAF sends an Authenticate Request including RES* to the AUSF.

### UE authenticated by the home network

At operation 317, the AUSF compares the received RES* with the stored XRES*. If the RES* and XRES* are equal, then AUSF considers the authentication successful from the home network point of view.

At operation 318a, the AUSF sends an Authenticate Response to the SEAF to inform the SEAF of the authentication result. If the authentication was successful, the SUPI and the K_{SEAF} key is included in the Authenticate Response. At operation 318b, the AUSF also informs the UDM about the authentication result (containing the SUPI, timestamp of authentication, authentication type and serving network name) in an Authentication Result confirmation Request message.

At operation 319, the SEAF generates a K_{AMF} key with the received K_{SEAF}, IMSI and ABBA parameter. The SEAF shares the generated K_{AMF} and ngKSI with the AMF.

### Authentication results storage

At operation 320, the UDM stores the authentication status of the UE.

At operation 321, the UDM replies to the AUSF with the Authentication Result Confirmation Response message.

The present disclosure relates to post quantum cryptography (PQC) enhancement of authentication and key agreement (AKA) procedures for use in communication networks. In some examples, Post-Quantum Pre-Shared Keys (PPKs) are mixed with symmetric keys to provide an additional layer of quantum safety to known AKA procedures such as described in relation to FIGS. 3A-3B. In other examples, pure post-quantum asymmetric algorithms are introduced, e.g., for 6G AKA procedures to further enhance quantum safety.

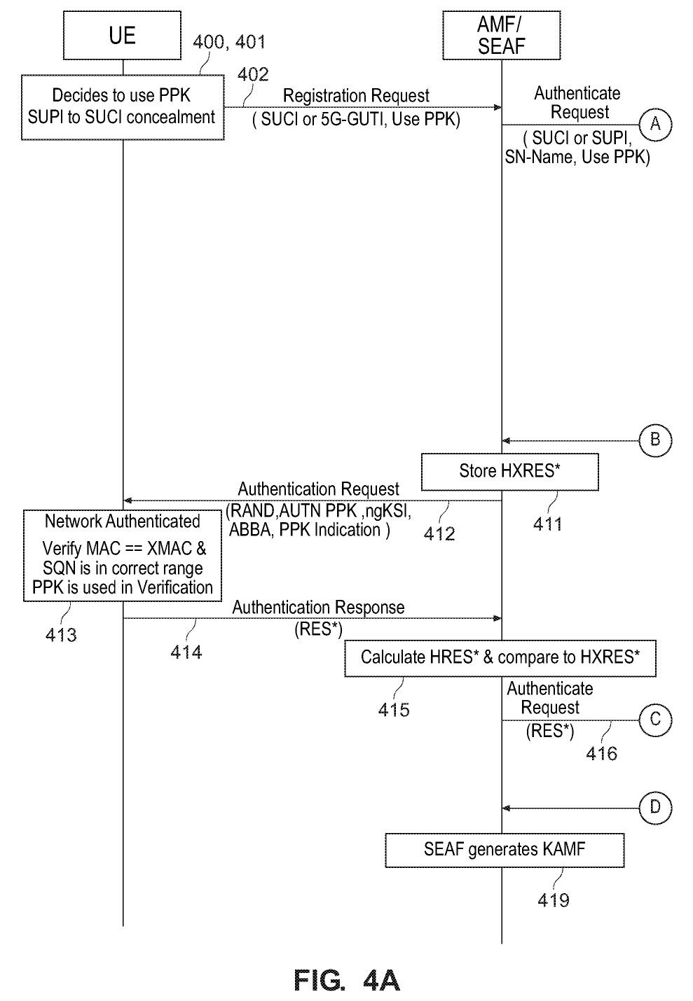

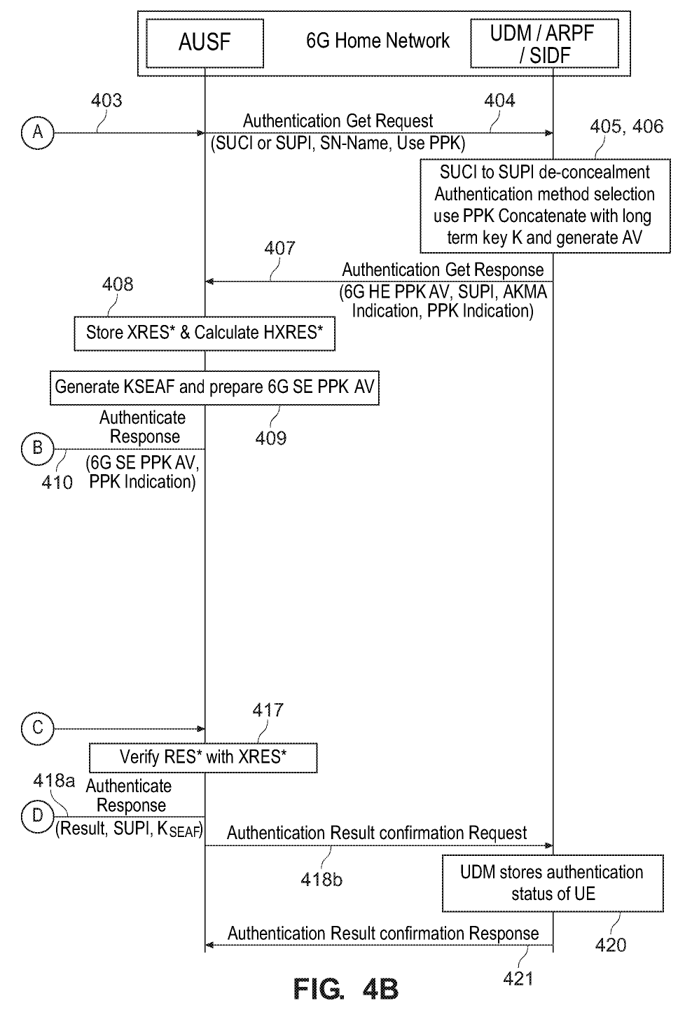

Referring to FIGS. 4A-4B, there is described one example of AKA using PPKs.

### UE initiating a registration procedure

At operation 400, a pre-shared post quantum key (PPK) is provisioned in the USIM and the UDM and can be referenced by the SUPI. The UE decides to request to use PPK for a Primary Authentication procedure.

At operation 401, the UE performs SUPI to SUCI concealment.

At operation 402, the UE transmits a Registration Request to the AMF. The Registration Request includes the SUCI or a 5G Global Unique Temporary Identifier (5G-GUTI) and an indication to use PPK.

At operation 403, the SEAF sends an Authenticate Request to the AUSF to initiate an authentication. The Authenticate Request includes the SUCI or SUPI, the serving network name (SN-Name) and an indication to use PPK.

At operation 404, if the serving network is authorized, the AUSF sends an Authentication Get Request to the UDM of the home network. The Authentication Get Request includes the SUCI or SUPI, and the serving network name and an indication to use PPK.

At operation 405, the UDM invokes the SIDF if the SUCI is received, and performs SUCI to SUPI de-concealment. The UDM selects the authentication method (5G AKA, EAP-AKA' or EAP-TLS) for primary authentication based on the SUPI, and will give the inputs for invoking the authentication method to the AUSF.

### Home network computes an AKA challenge

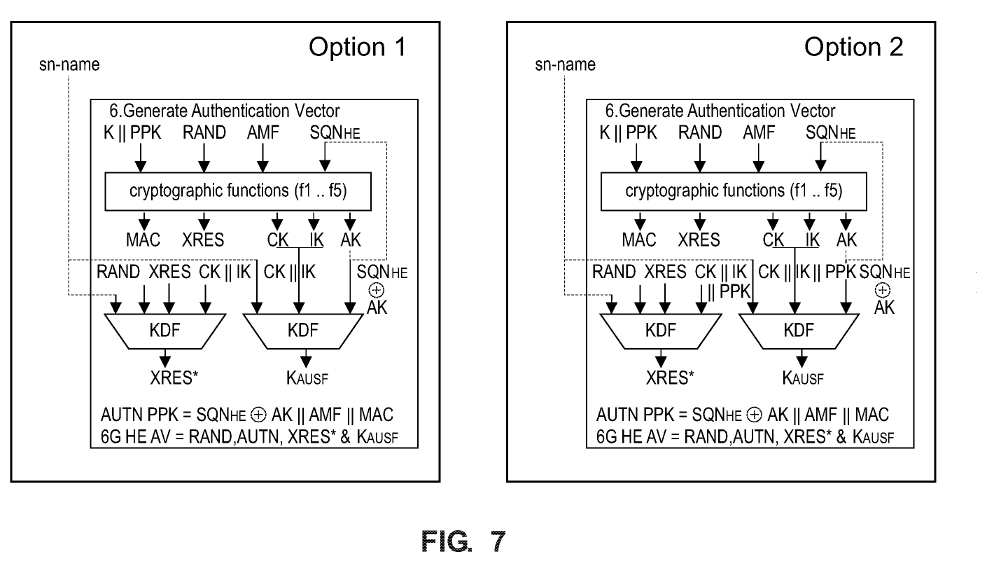

At operation 406, the UDM decides to use the PPK for an AKA challenge. Referring to FIG. 7, there are two options for using PPK for an AKA challenge.

In FIG. 7, option 1, PPK is concatenated with the long term key K, yielding K||PPK . The UDM using cryptographic functions (f1, f2, f3, f4, f5), computes a message authentication code (MAC), expected response (XRES), a cipher key (CK), an integrity key (IK) and an anonymity key (AK), with inputs including K||PPK, a generated new random number (RAND), an authentication and key management field AMF and a freshly generated sequence number (SQN) (created by incrementing a stored non time based SQN or time based SQN generation of partial time based SQN generation). The UDM, using key derivative functions (KDF), derives a K_{AUSF} key and calculates an expected enhanced response (XRES*) to a challenge. The K_{AUSF} key is derived from a KDF with inputs including the concatenation (CK||IK) of CK and IK. XRES* is derived from a KDF with inputs including RAND, XRES and CK||IK. In option 1, the UDM derives Post-Quantum Pre-Shared Key authentication token (AUTN PPK) based on SQN, AK, AMF and MAC. The UDM then creates a 6G Home Environment Authentication Vector (6G HE PPK AV) containing RAND, an authentication token (AUTN), the expected response (XRES*) and K_{AUSF}. The notation “AUTN PPK” and “6G HE PPK AV” are used to denote AUTN and AV derived in part using PPK.

In FIG. 7, option 2, PPK is concatenated with CK and IK, yielding CK||IK||PPK. The UDM using cryptographic functions (f1, f2, f3, f4, f5), computes a MAC, XRES, CK, IK and AK with inputs including K, RAND, AMF and SQN. The UDM, using key derivative functions (KDF), derives K_{AUSF} and XRES*. K_{AUSF} is derived from a KDF with inputs including the concatenation (CK||IK||PPK) of CK, IK and PPK. XRES* is derived from a KDF with inputs including RAND, XRES and CK||IK||PPK. In option 2, the UDM derives an authentication token (AUTN) based on SQN, AK, AMF and MAC. The UDM then creates a 6G Home Environment Authentication Vector (6G HE PPK AV) containing RAND, the authentication token (AUTN), the expected enhanced response (XRES*) and K_{AUSF}.

In option 1, both AUTN PPK and 6G HE PPK AV are influenced by the PPK, meaning that they are derived in part using the PPK. AUTN PPK is influenced by the PPK because at least AK and MAC are derived from cryptographic functions including K||PPK as an input. 6G HE PPK AV is influenced by PPK because is derived in part from AUTN PPK and from XRES*, both of which are influenced by the PPK. In option 2, 6G HE PPK AV is influenced by the PPK, meaning that it is derived in part using the PPK, because it is derived in part from XRES* and from K_{AUSF}, both of which includes CK||IK||PPK as an input.

At operation 407, the UDM sends an Authentication Get Response to the AUSF with the 6G HE PPK AV, SUPI and an Authentication and Key Management for Application (AKMA) indication, and an indication to use AKA challenge with PPK.

At operation 408, the AUSF stores the expected enhanced response (XRES*) temporarily with the received SUCI or SUPI. The AUSF then calculates a hash expected enhanced response (HXRES*) from the expected enhanced response (XRES*) by using the SHA-256 algorithm with the concatenated inputs RAND and XRES*.

At operation 409, the AUSF generates the K_{SEAF} key from the K_{AUSF} key, and prepares a 6G Serving Environment Post-Quantum Pre-Shared Key Authentication Vector (6G SE PPK AV). The 6G SE PPK AV includes the random challenge (RAND), authentication token (AUTN), and the hash expected response (HXRES*).

At operation 410, the AUSF sends an Authenticate Response to the SEAF that includes the 6G SE PPK AV and the indication to use PPK for the AKA challenge.

At operation 411, the SEAF stores the HXRES*.

At operation 412, the SEAF sends an Authentication Request to the UE. The Authentication Request includes RAND, AUTN PPK (AKA challenge with PPK) and PPK indication along with the next-generation key set identifier (ngKSI) and an Anti-Bidding down Between Architectures (ABBA) parameter.

### Network authenticated by the UE

The UE includes Mobile Equipment (ME) and a USIM. The ME receives the authentication token (AUTN PPK, e.g., in FIG. 7, option 1, or AUTN, e.g., in FIG. 7, option 2), random challenge (RAND) and PPK indication in the Authentication Request and forwards them to the USIM.

At operation 413, the USIM verifies the integrity of the authentication token (e.g., AUTN PPK (option 1), or AUTN (option 2)) by retrieving the MAC from the authentication token; retrieving the PPK based on the PPK indication, computing an expected MAC (XMAC) (using cryptographic functions with inputs corresponding to option 1 or option 2, corresponding to that used by the UDM), and verifies AUTN PPK integrity (option 1) or AUTN integrity (option 2) if MAC = XMAC. If AUTN PPK (option 1) or AUTN integrity (option 2) is verified, the USIM computes a response (RES).

The USIM also computes CK and IK, and returns the response (RES), the CK key, and the IK key to the ME. The ME then computes RES* from RES, calculates the K_{AUSF} key, and calculates the K_{SEAF} key from the K_{AUSF} key. In option 1, PPK is used in part to verify AUTN PPK and also to calculate the response (RES), K_{AUSF} and RES*. In option 2, PPK is used in part to calculate K_{AUSF} and RES*.

In one embodiment, similar to FIG. 7, option 1, K_{AUSF} is derived from a KDF with inputs including the concatenation (CK||IK) of CK and IK (with CK and IK influenced by K||PPK); and XRES* is derived from a KDF with inputs including RAND, XRES and CK||IK. In another embodiment, similar to FIG. 7, option 2, K_{AUSF} is derived from a KDF with inputs including the concatenation (CK||IK||PPK) of CK, IK and PPK. XRES* is derived from a KDF with inputs including RAND, XRES and CK||IK||PPK.

At operation 414, the UE sends an Authentication Response to the SEAF that includes RES*.

### UE authenticated by the serving network

At operation 415, the SEAF computes HRES* using the SHA-256 hashing algorithm from the received response RES*, and compares HRES* with the expected hash value HXRES*. If the compared values are equal, SEAF considers the authentication successful from the serving network point of view.

At operation 416, the SEAF sends an Authenticate Request including RES* to the AUSF.

### UE authenticated by the home network

At operation 417, the AUSF compares the received RES* with the stored XRES*. If the RES* and XRES* are equal, then AUSF considers the authentication successful from the home network point of view.

At operation 418a, the AUSF sends an Authenticate Response to the SEAF to inform the SEAF of the authentication result. If the authentication was successful, the SUPI and the K_{SEAF} key is included in the Authenticate Response. At operation 18b, the AUSF also informs the UDM about the authentication result (containing the SUPI, timestamp of authentication, authentication type and serving network name) in an Authentication Result confirmation Request message.

At operation 419, the SEAF generates a K_{AMF} key with the received K_{SEAF}, IMSI and ABBA parameter. The SEAF shares the generated K_{AMF} and ngKSI with the AMF.

### Authentication results storage

At operation 420, the UDM stores the authentication status of the UE.

At operation 421, the UDM replies to the AUSF with the Authentication Result Confirmation Response message.

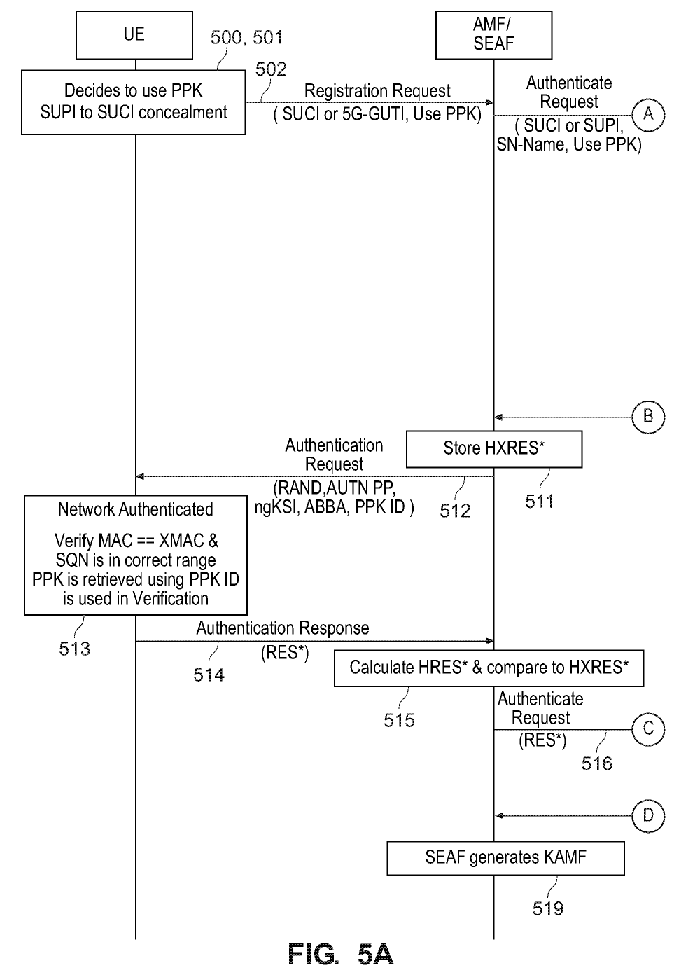

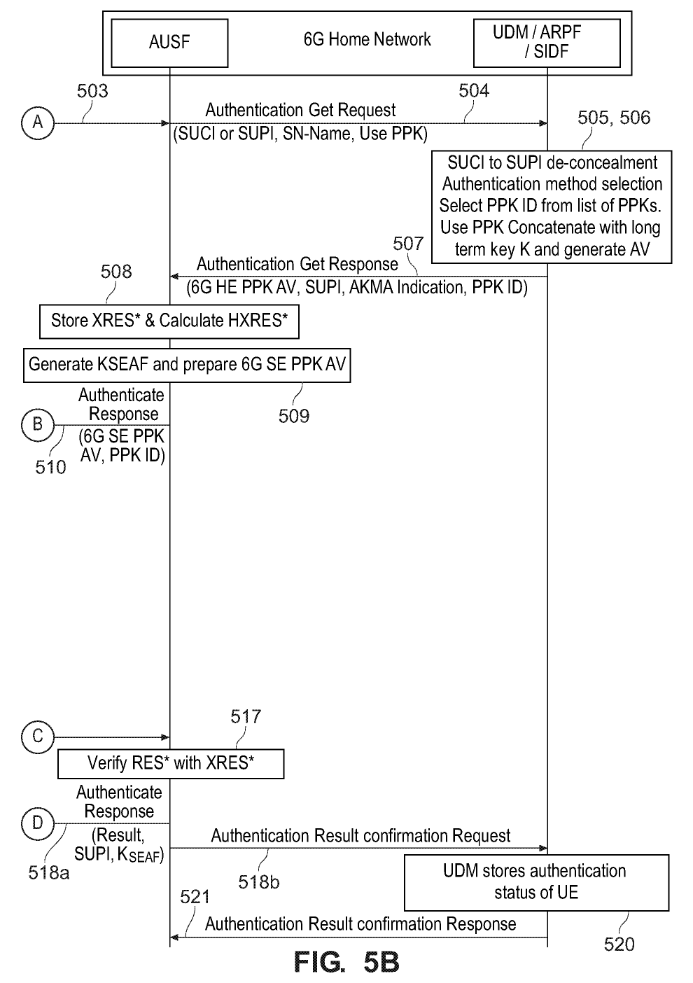

Now referring to FIGS. 5A-5B, there is described another example of AKA using PPKs.

### UE initiating a registration procedure

At operation 500, a list of pre-shared post quantum keys (PPKs) is provisioned in the USIM and the UDM and can be referenced by the SUPI. The UE decides to request to use PPK for a Primary Authentication procedure.

At operation 501, the UE performs SUPI to SUCI concealment.

At operation 502, the UE transmits a Registration Request to the AMF. The Registration Request includes the SUCI or a 5G Global Unique Temporary Identifier (5G-GUTI) and an indication to use PPK.

At operation 503, the SEAF sends an Authenticate Request to the AUSF to initiate an authentication. The Authenticate Request includes the SUCI or SUPI, the serving network name (SN-Name) and an indication to use PPK.

At operation 504, if the serving network is authorized, the AUSF sends an Authentication Get Request to the UDM of the home network. The Authentication Get Request includes the SUCI or SUPI, and the serving network name and an indication to use PPK.

At operation 505, the UDM invokes the SIDF if the SUCI is received, and performs SUCI to SUPI de-concealment. The UDM selects the authentication method (5G AKA, EAP-AKA' or EAP-TLS) for primary authentication based on the SUPI, and will give the inputs for invoking the authentication method to the AUSF.

### Home network computes an AKA challenge

At operation 506, the UDM decides to use PPK for an AKA challenge. The UDM selects one of the PPKs from the list of PPKs based on the PPK ID and retrieves the associated PPK value.

In FIG. 7, option 1, the selected PPK is concatenated with the long term key K, yielding K||PPK . The UDM using cryptographic functions (f1, f2, f3, f4, f5), computes a message authentication code (MAC), expected response (XRES), a cipher key (CK), an integrity key (IK) and an anonymity key (AK), with inputs including K||PPK, a generated new random number (RAND), an authentication and key management field AMF and a freshly generated sequence number (SQN) (created by incrementing a stored non time based SQN or time based SQN generation of partial time based SQN generation). The UDM, using key derivative functions (KDF), derives a K_{AUSF} key and calculates an expected enhanced response (XRES*) to a challenge. The K_{AUSF} key is derived from a KDF with inputs including the concatenation (CK||IK) of CK and IK. XRES* is derived from a KDF with inputs including RAND, XRES and CK||IK. In option 1, the UDM derives an authentication token (AUTN PPK) based on SQN, AK, AMF and MAC. The UDM then creates a 6G Home Environment Authentication Vector (6G HE PPK AV) containing RAND, an authentication token (AUTN), the expected response (XRES*) and K_{AUSF}.

In FIG. 7, option 2, PPK is concatenated with CK and IK, yielding CK||IK||PPK. The UDM using cryptographic functions (f1, f2, f3, f4, f5), computes a MAC, XRES, CK, IK and AK with inputs including K, RAND, AMF and SQN. The UDM, using key derivative functions (KDF), derives K_{AUSF} and XRES*. K_{AUSF} is derived from a KDF with inputs including the concatenation (CK||IK||PPK) of CK, IK and PPK. XRES* is derived from a KDF with inputs including RAND, XRES and CK||IK||PPK. In option 2, the UDM derives an authentication token (AUTN) based on SQN, AK, AMF and MAC. The UDM then creates a 6G Home Environment Authentication Vector (6G HE PPK AV) containing RAND, the authentication token (AUTN), the expected response (XRES*) and K_{AUSF}.

In option 1, both AUTN PPK and 6G HE PPK AV are influenced by the selected PPK, meaning that they are derived in part using the selected PPK. AUTN PPK is influenced by the selected PPK because at least AK and MAC are derived from cryptographic functions including K||PPK as an input. 6G HE PPK AV is influenced by the selected PPK because is derived in part from AUTN PPK and from XRES*, both of which are influenced by the selected PPK. In option 2, 6G HE PPK AV is influenced by the selected PPK, meaning that it is derived in part using the selected PPK, because it is derived in part from XRES* and from K_{AUSF}, both of which includes CK||IK||PPK as an input.

At operation 507, the UDM sends an Authentication Get Response to the AUSF with the 6G HE AV, SUPI and an Authentication and Key Management for Application (AKMA) indication, and an indication to use PPK (with the PPK identified by PPK ID) for the AKA challenge.

At operation 508, the AUSF stores the expected enhanced response (XRES*) temporarily with the received SUCI or SUPI. The AUSF then calculates a hash expected enhanced response (HXRES*) from the expected enhanced response (XRES*) by using the SHA-256 algorithm with the concatenated inputs RAND and XRES*.

At operation 509, the AUSF generates the K_{SEAF} key from the K_{AUSF} key, and prepares a 5G Serving Environment Authentication Vector (5G SE AV). The 5G SE AV includes the authentication token (AUTN), hash expected response (HXRES*), and the random challenge (RAND).

At operation 510, the AUSF sends an Authenticate Response to the SEAF that includes the 6G SE AV and the indication to use PPK (with the PPK identified by PPK ID) for the AKA challenge.

At operation 511, the SEAF stores the HXRES*.

At operation 512, the SEAF sends an Authentication Request to the UE. The Authentication Request includes RAND, AUTN PPK (AKA challenge with PPK) and PPK indication (with the PPK identified by PPK ID) along with the next-generation key set identifier (ngKSI) and an Anti-Bidding down Between Architectures (ABBA) parameter.

### Network authenticated by the UE

The UE includes Mobile Equipment (ME) and a USIM. The ME receives the authentication token (AUTN PPK, e.g., in FIG. 7, option 1, or AUTN, e.g., in FIG. 7, option 2), random challenge (RAND) and PPK indication in the Authentication Request and forwards them to the USIM. At operation 513, the USIM verifies the integrity of the authentication token (e.g., AUTN PPK (option 1), or AUTN (option 2)) by retrieving the MAC from the authentication token; retrieving the selected PPK from the list of PPKs based on the PPK indication, computing an expected MAC (XMAC) (using cryptographic functions with inputs corresponding to option 1 or option 2, corresponding to that used by the UDM), and verifies AUTN PPK integrity (option 1) or AUTN integrity (option 2) if MAC = XMAC. If AUTN PPK or AUTN integrity is verified, the USIM computes a response (RES).

The USIM also computes CK and IK, and returns the response (RES), the CK key, and the IK key to the ME. The ME then computes RES* from RES, calculates the K_{AUSF} key, and calculates the K_{SEAF} key from the K_{AUSF} key. In option 1, the selected PPK is used in part to verify AUTN PPK and also to calculate the response (RES), K_{AUSF} and RES*. In option 2, the selected PPK is used in part to calculate K_{AUSF} and RES*.

In one embodiment, similar to FIG. 7, option 1, K_{AUSF} is derived from a KDF with inputs including the concatenation (CK||IK) of CK and IK (with CK and IK influenced by K||PPK); and XRES* is derived from a KDF with inputs including RAND, XRES and CK||IK. In another embodiment, similar to FIG. 7, option 2, K_{AUSF} is derived from a KDF with inputs including the concatenation (CK||IK||PPK) of CK, IK and PPK. XRES* is derived from a KDF with inputs including RAND, XRES and CK||IK||PPK.

At operation 514, the UE sends an Authentication Response to the SEAF that includes RES*.

### UE authenticated by the serving network

At operation 515, the SEAF computes HRES* using the SHA-256 hashing algorithm from the received response RES*, and compares HRES* with the expected hash value HXRES*. If the compared values are equal, SEAF considers the authentication successful from the serving network point of view.

At operation 516, the SEAF sends an Authenticate Request including RES* to the AUSF.

### UE authenticated by the home network

At operation 517, the AUSF compares the received RES* with the stored XRES*. If the RES* and XRES* are equal, then AUSF considers the authentication successful from the home network point of view.

At operation 518a, the AUSF sends an Authenticate Response to the SEAF to inform the SEAF of the authentication result. If the authentication was successful, the SUPI and the K_{SEAF} key is included in the Authenticate Response. At operation 518b, the AUSF also informs the UDM about the authentication result (containing the SUPI, timestamp of authentication, authentication type and serving network name) in an Authentication Result confirmation Request message.

At operation 519, the SEAF generates a K_{AMF} key with the received K_{SEAF}, IMSI and ABBA parameter. The SEAF shares the generated K_{AMF} and ngKSI with the AMF.

### Authentication results storage

At operation 520, the UDM stores the authentication status of the UE.

At operation 521, the UDM replies to the AUSF with the Authentication Result Confirmation Response message.

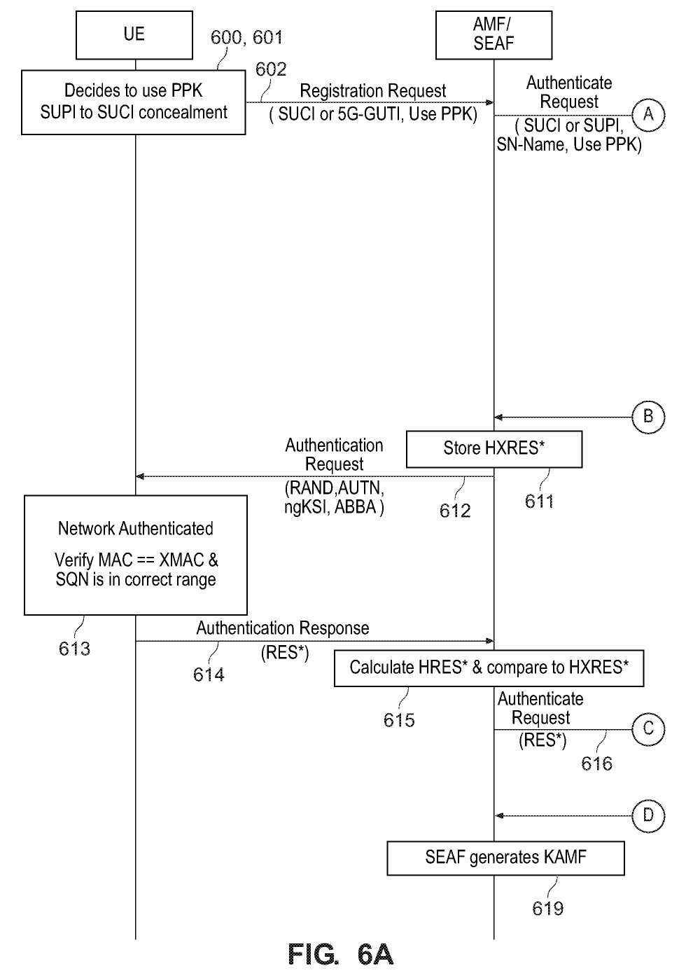

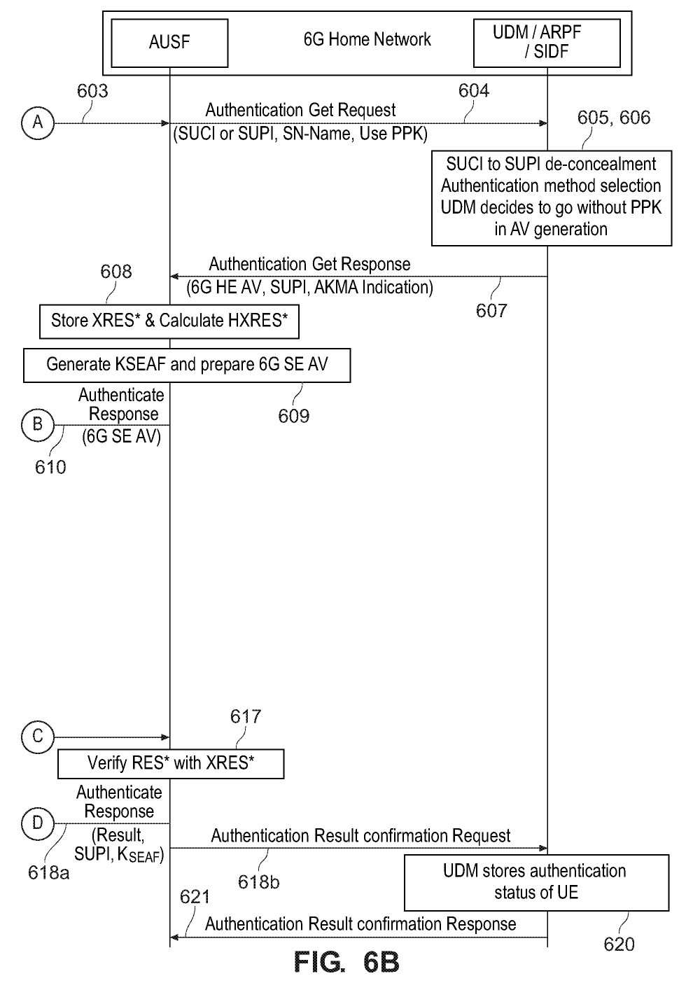

Now referring to FIGS. 6A-6B, there is described one example of AKA with PPK requested by the UE but not used by the UDM. For convenience, only the first 6 operations will be described.

### UE initiating a registration procedure

At operation 600, a pre-shared post quantum key (PPK) is provisioned in the USIM and the UDM and can be referenced by the SUPI. The UE decides to request to use PPK for a Primary Authentication procedure.

At operation 601, the UE performs SUPI to SUCI concealment.

At operation 602, the UE transmits a Registration Request to the AMF. The Registration Request includes the SUCI or a 5G Global Unique Temporary Identifier (5G-GUTI) and an indication to use PPK.

At operation 603, the SEAF sends an Authenticate Request to the AUSF to initiate an authentication. The Authenticate Request includes the SUCI or SUPI, the serving network name (SN-Name) and an indication to use PPK.

At operation 604, if the serving network is authorized, the AUSF sends an Authentication Get Request to the UDM of the home network. The Authentication Get Request includes the SUCI or SUPI, and the serving network name and an indication to use PPK.

At operation 605, the UDM invokes the SIDF if the SUCI is received, and performs SUCI to SUPI de-concealment. The UDM selects the authentication method for primary authentication based on the SUPI.

At operation 606, the UDM decides to not to use the PPK for an AKA challenge. Instead, the UDM generates an Authentication Vector without PPK such as described in relation to FIGS. 3A-3B. The remaining operations are repetitive to that of FIGS. 3A-3B, except for “600” series reference numbers.

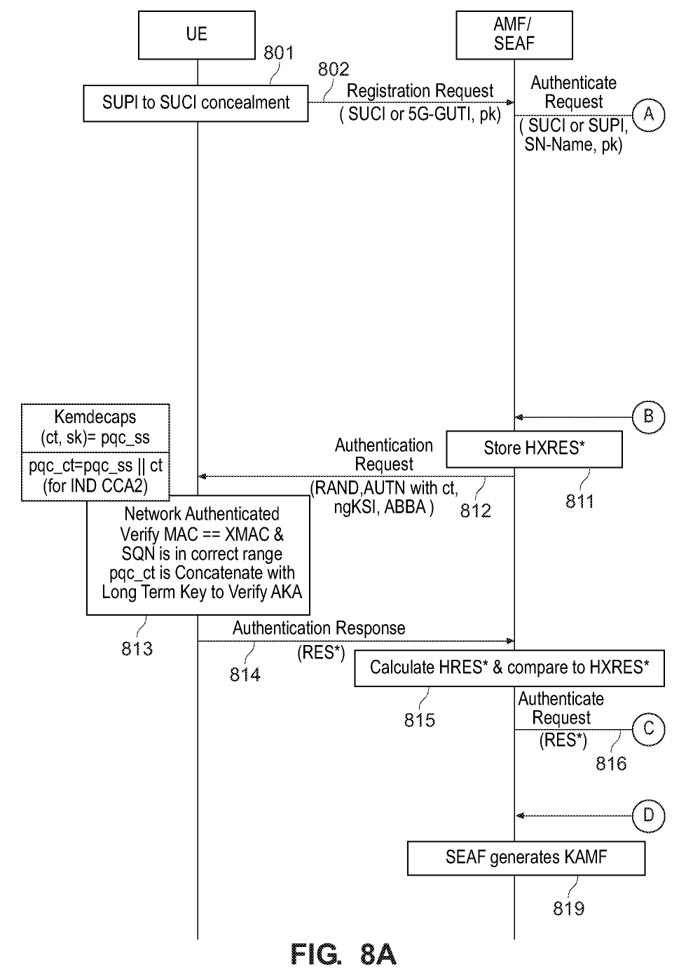

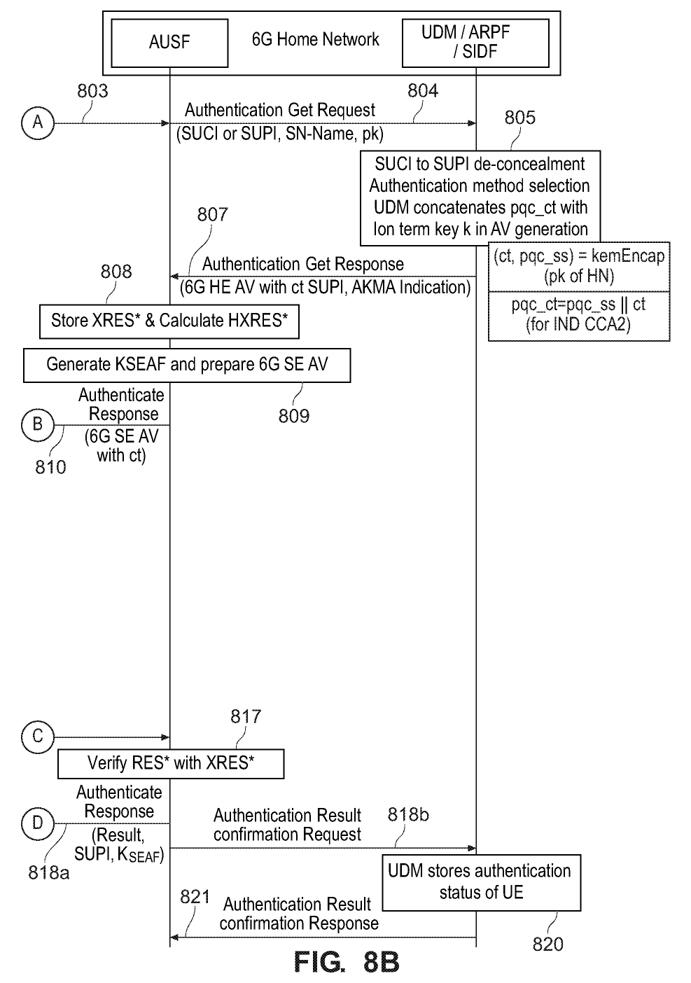

Now referring to FIGS. 8A-8B, there is described one example that uses pure post-quantum cryptography (PQC), e.g., for 6G AKA procedures to further enhance quantum safety.

### UE initiating a registration procedure

At operation 800, the UE generates a post quantum cryptography (PQC) Home Network public key (pk) and private key (sk) using a PQC kemkeyGen function.

At operation 801, the UE performs SUPI to SUCI concealment.

At operation 802, the UE transmits a Registration Request to the AMF. The Registration Request includes the SUCI or a 5G Global Unique Temporary Identifier (5G-GUTI) and the PQC public key (pk).

At operation 803, the SEAF sends an Authenticate Request to the AUSF to initiate an authentication. The Authenticate Request includes the SUCI or SUPI, the serving network name (SN-Name) and the PQC public key (pk).

At operation 804, if the serving network is authorized, the AUSF sends an Authentication Get Request to the UDM of the home network. The Authentication Get Request includes the SUCI or SUPI, the serving network name and the PQC public key (pk).

At operation 805, the UDM invokes the SIDF if the SUCI is received, and performs SUCI to SUPI de-concealment. The UDM selects the authentication method (5G AKA, EAP-AKA' or EAP-TLS) for primary authentication based on the SUPI, and will give the inputs for invoking the authentication method to the AUSF.

### Home network computes a PQC AKA challenge

At operation 806, the UDM decides to use PQC for an AKA challenge. The UDM uses a PQC kemEncaps function with the public key (pk) to generate a shared secret (pqc_ss) and cipher text (ct). For IND-CCA2, the pqc_ss is concatenated with ct to form pqc_ct. IND-CCA2 (INDistinguishability under adaptive Chosen-Ciphertext Attack) is an advanced security notion for encryption schemes that will be understood to those skilled in the art. The UDM concatenates pqc_ct with the long term key (k) for the AKA challenge.

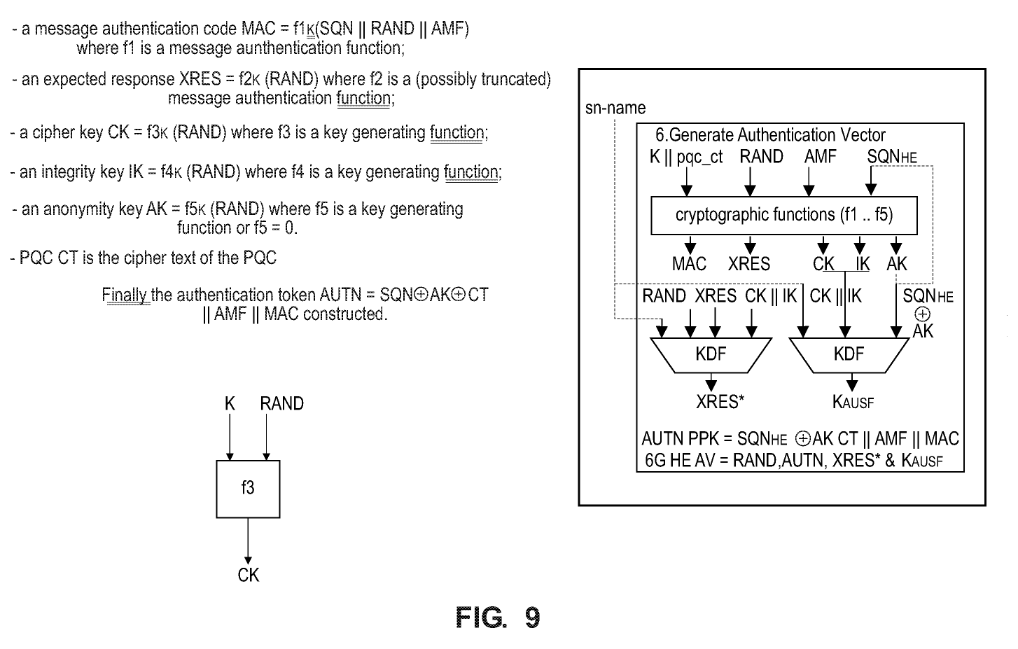

Referring to FIG. 9, the UDM using cryptographic functions (f1K, f2K, f3K, f4K, f5K), computes a message authentication code (MAC), an expected response (XRES), a cipher key (CK), an integrity key (IK) and an anonymity key (AK), with inputs including the long term key (K) concatenated with pqc_ct, RAND, AMF and SQN. It is noted, the notation f1K, f2K, etc. refers to the corresponding cryptographic function (f1, f2, f3, f4, f5) with inputs concatenated with k (e.g., in one illustrated example, f3K(RAND) refers to cryptographic function f3 with input of RAND and long term key K concatenated with pqc_ct, yielding the output CK).

The UDM, using key derivative functions (KDF), derives a K_{AUSF} key with inputs including the concatenation (CK||IK) of CK and IK cipher key CK, integrity key IK, SNN and “XOR” of SQN and AK. The UDM also calculates an expected enhanced response (XRES*) from a KDF with inputs including RAND, XRES, SNN and CK||IK. The UDM derives an authentication token (AUTN) based on SQN, AK, ct, AMF and MAC. The UDM then creates a 6G Home Environment Authentication Vector (6G HE AV) containing RAND, AUTN, XRES* and K_{AUSF}.

For convenience, “AUTN with ct” and “6G HE AV with ct” are used to denote AUTN and 6G HE AV derived in part using ct. AUTN with ct is derived in part using ct for at least the reason that it is computed based in part on ct and in part on at AK and MAC which are derived from cryptographic functions including K||pqc_ct as an input. 6G HE AV with ct is derived in part using ct for at least the reason that it is computed in part from AUTN with ct and in part from XRES*, which is influenced by K||pqc_ct.

At operation 807, the UDM sends an Authentication Get Response to the AUSF with the 6G HE AV with ct, SUPI, an Authentication and Key Management for Application (AKMA) indication and cipher text (ct).

At operation 808, the AUSF stores the expected enhanced response (XRES*) temporarily with the received SUPI. The AUSF then calculates a hash expected enhanced response (HXRES*) from the expected response (XRES*) by using the SHA-256 algorithm with the concatenated inputs RAND and XRES*.

At operation 809, the AUSF generates the K_{SEAF} key from a KDF with inputs including K_{AUSF} and SNN, and prepares a 6G Serving Environment Authentication Vector (6G SE AV with ct). The 6G SE AV includes the random challenge (RAND), authentication token (AUTN with ct), and the hash expected enhanced response (HXRES*).

At operation 810, the AUSF sends an Authenticate Response to the SEAF that includes the 6G SE AV and with ct.

At operation 811, the SEAF stores the HXRES*.

At operation 812, the SEAF sends an Authentication Request to the UE. The Authentication Request includes RAND, AUTN with ct, a next-generation key set identifier (ngKSI) and an Anti-Bidding down Between Architectures (ABBA) parameter.

### Network authenticated by the UE

The UE includes Mobile Equipment (ME) and a USIM. The ME receives AUTN with ct and RAND) in the Authentication Request and forwards them to the USIM.

At operation 813, the USIM retrieves MAC, SQN and ct from the authentication token (e.g., AUTN with ct) and verifies the authentication token by first using a PQC kemdecaps function with the cipher text (ct) and the private key (sk) to generate a shared secret (pqc_ss). For IND-CCA2, the pqc_ss is concatenated with ct to form pqc_ct. The UDM concatenates pqc_ct with the long term key (k) for the AKA challenge. The USIM then computes an expected MAC (XMAC) using cryptographic function f1, with inputs including SQN, RAND, AMF and the long term key (k) concatenated with pqc_ct, corresponding to that used by the UDM, see FIG. 9; and comparing MAC and XMAC. Integrity is verified and AUTN with ct is accepted if MAC = XMAC and SQN is in the correct range. If AUTN with ct is accepted, USIM computes a response (RES). The USIM also computes CK and IK, and returns the response (RES), CK and IK to the ME. The ME then computes RES* from RES, calculates the K_{AUSF} key, and calculates the K_{SEAF} key from the K_{AUSF} key, similar to generation at the UDM.

At operation 814, the UE sends an Authentication Response to the SEAF that includes RES*.

### UE authenticated by the serving network

At operation 815, the SEAF computes HRES* using the SHA-256 hashing algorithm from the received response RES*, and compares HRES* with the expected hash value HXRES*. If the compared values are equal, SEAF considers the authentication successful from the serving network point of view.

At operation 816, the SEAF sends an Authenticate Request including RES* to the AUSF.

### UE authenticated by the home network

At operation 817, the AUSF compares the received RES* with the stored XRES*. If the RES* and XRES* are equal, then AUSF considers the authentication successful from the home network point of view.

At operation 818a, the AUSF sends an Authenticate Response to the SEAF to inform the SEAF of the authentication result. If the authentication was successful, the SUPI and the K_{SEAF} key is included in the Authenticate Response. At operation 818b, the AUSF also informs the UDM about the authentication result (containing the SUPI, timestamp of authentication, authentication type and serving network name) in an Authentication Result confirmation Request message.

At operation 819, the SEAF generates a K_{AMF} key with the received K_{SEAF}, IMSI and ABBA parameter. The SEAF shares the generated K_{AMF} and ngKSI with the AMF.

### Authentication results storage

At operation 820, the UDM stores the authentication status of the UE.

At operation 821, the UDM replies to the AUSF with the Authentication Result Confirmation Response message.

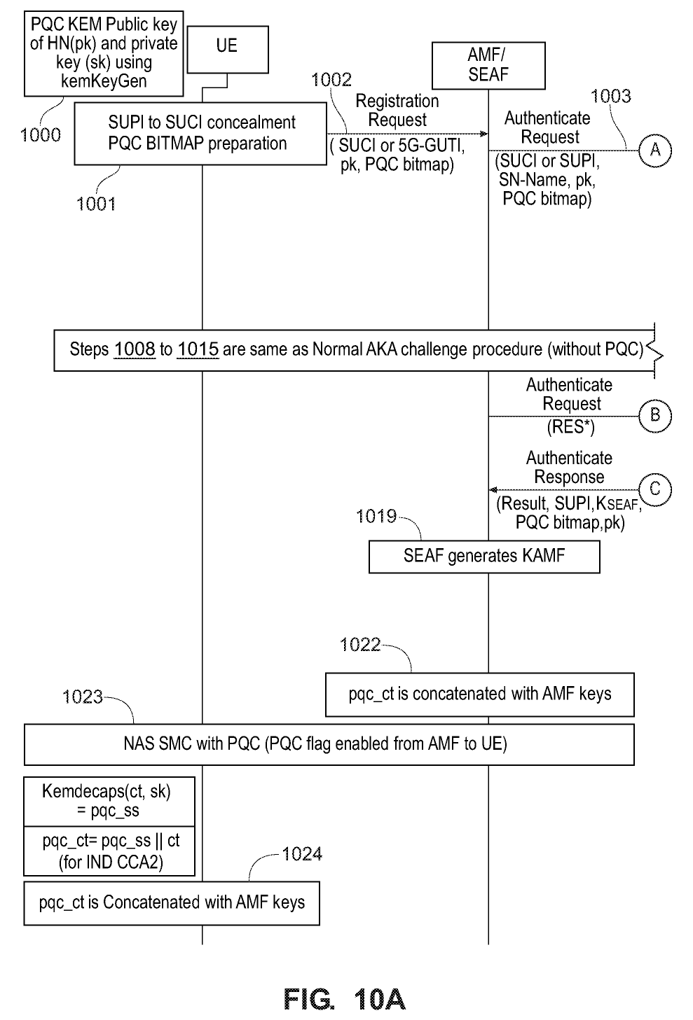

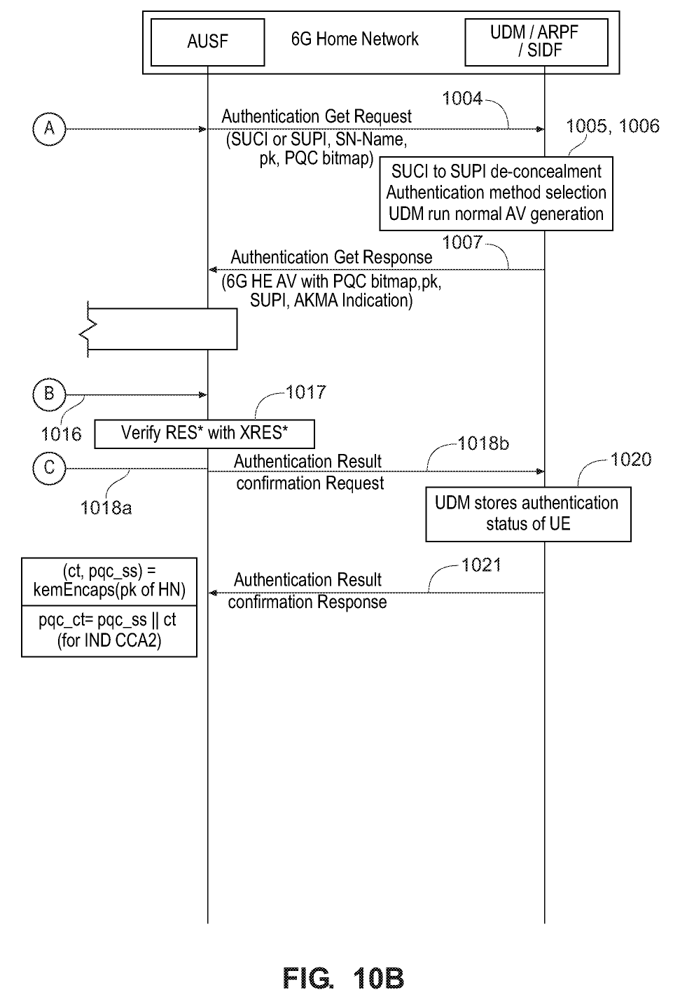

Now referring to FIGS. 10A-10B, there is described a second example that uses pure post-quantum cryptography (PQC), e.g., for 6G AKA procedures to further enhance quantum safety.

### UE initiating a registration procedure

At operation 1000, the UE generates a post quantum cryptography (PQC) KEM home network public key HN(pk) and private key (sk) using a PQC kemkeyGen function.

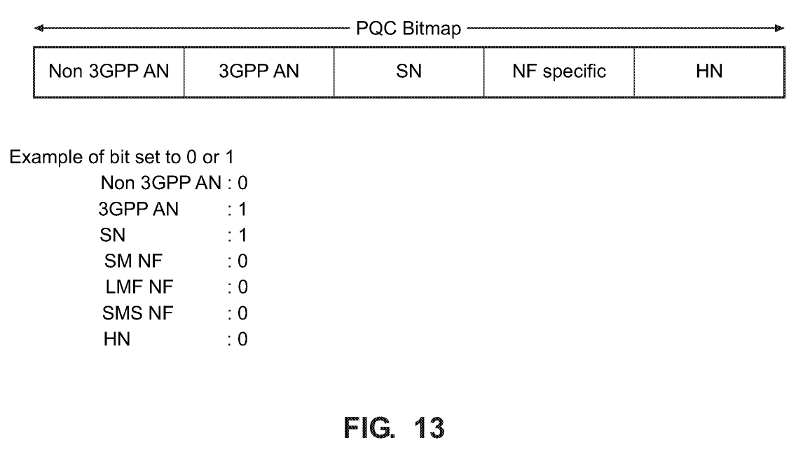

At operation 1001, the UE performs SUPI to SUCI concealment and prepares a PQC bitmap. An example PQC bitmap is shown at FIG. 13. In the example of FIG. 13, bits are set for the entities that support PQC. As shown, bits are set to “1” for 3GPP AN and serving network (SN), meaning the AN and SN support PQC; and bits are set to “0” for non 3GPP AN, SM NF, LMF NF, SMS NF and HN, meaning those entities do not support PQC. For those entities supporting PQC, AS SMC and NAS SMC will be run and the PQC shared keys are generated and concatenated with NAS and AS keys independently.

At operation 1002, the UE transmits a Registration Request to the AMF. The Registration Request includes the SUCI or a 5G Global Unique Temporary Identifier (5G-GUTI), the PQC public key (pk) and the PQC bitmap.

At operation 1003, the SEAF sends an Authenticate Request to the AUSF to initiate an authentication. The Authenticate Request includes the SUCI or SUPI, the serving network name (SN-Name), the PQC public key (pk) and the PQC bitmap.

At operation 1004, if the serving network is authorized, the AUSF sends an Authentication Get Request to the UDM of the home network. The Authentication Get Request includes the SUCI or SUPI, the serving network name, the PQC public key (pk) and the PQC bitmap.

At operation 1005, the UDM invokes the SIDF if the SUCI is received, and performs SUCI to SUPI de-concealment. The UDM selects the authentication method (5G AKA, EAP-AKA' or EAP-TLS) for primary authentication based on the SUPI, and will give the inputs for invoking the authentication method to the AUSF.

### Home network computes a PQC AKA challenge

At operation 1006, the UDM performs a normal AV generation, such as described in relation to FIGS. 3A-3B, with the exception that it derives a 6G HE AV including the PQC bitmap.

At operation 1007, the UDM sends an Authentication Get Response to the AUSF with the 6G HE AV, SUPI, an Authentication and Key Management for Application (AKMA) indication, the PQC public key (pk) and the PQC bitmap.

Operations 1008 to 1015 are not shown, inasmuch as they are the same as a normal AKA challenge procedure (without PQC), such as described in relation to FIGS. 3A-3B operations 308 to 315.

At operation 1016, the SEAF sends an Authenticate Request including RES* to the AUSF.

### UE authenticated by the home network

At operation 1017, the AUSF compares the received RES* with the stored XRES*. If the RES* and XRES* are equal, then AUSF considers the authentication successful from the home network point of view.

At operation 1018a, the AUSF sends an Authenticate Response to the SEAF to inform the SEAF of the authentication result. If the authentication was successful, the SUPI and the K_{SEAF} key is included in the Authenticate Response along with the PQC public key (pk) and the PQC bitmap. At operation 1018b, the AUSF also informs the UDM about the authentication result (containing the SUPI, timestamp of authentication, authentication type and serving network name) in an Authentication Result confirmation Request message.

At operation 1019, the SEAF generates a K_{AMF} key with the received K_{SEAF}, IMSI and ABBA parameter. The SEAF shares the generated K_{AMF} and ngKSI with the AMF.

### Authentication results storage

At operation 1020, the UDM stores the authentication status of the UE.

At operation 1021, the UDM replies to the AUSF with the Authentication Result Confirmation Response message.

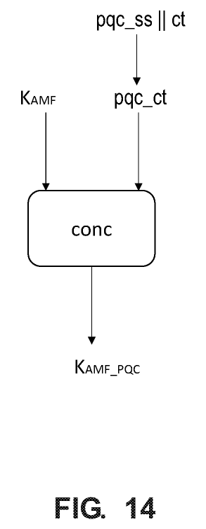

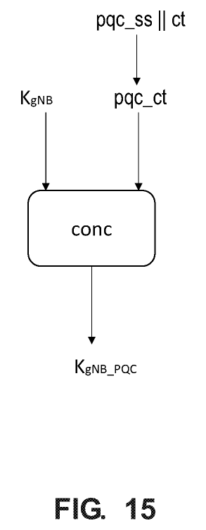

At operation 1022, the AMF uses a kemEncaps function with the public key (pk) to generate a shared secret (pqc_ss) and cipher text (ct). For IND_CCA2, the pqc_ss is concatenated with ct to form pqc_ct, and this value is concatenated with K_{AMF} to generate NAS keys, such as shown in FIG. 14. It is noted that the same procedure can be used for AS or RAN keys with PQC, for example, RAN key generation with PQC is shown at FIG. 15. NAS SMC is run between AMF and UE and AS SMC is run between RAN and UE.

At operation 1023, the AMF sends a non-access stratum (NAS) security mode command (SMC) message to the UE with a PQC flag (i.e., PQC indication) set. Therefore, the UE knows it is PQC SMC. The NAS SMC includes ct.

At operation 1024, the USIM uses a Kemdecaps function using the ct and sk to generate the shared secret (pqc_ss). Then, as shown in FIG. 14, the pqc_ss is concatenated with ct to form pqc_ct, and this value (pqc_ct) is concatenated with an AMF non-PQC key (KAMF) to derive an AMF PQC key (KAMF_PQC).

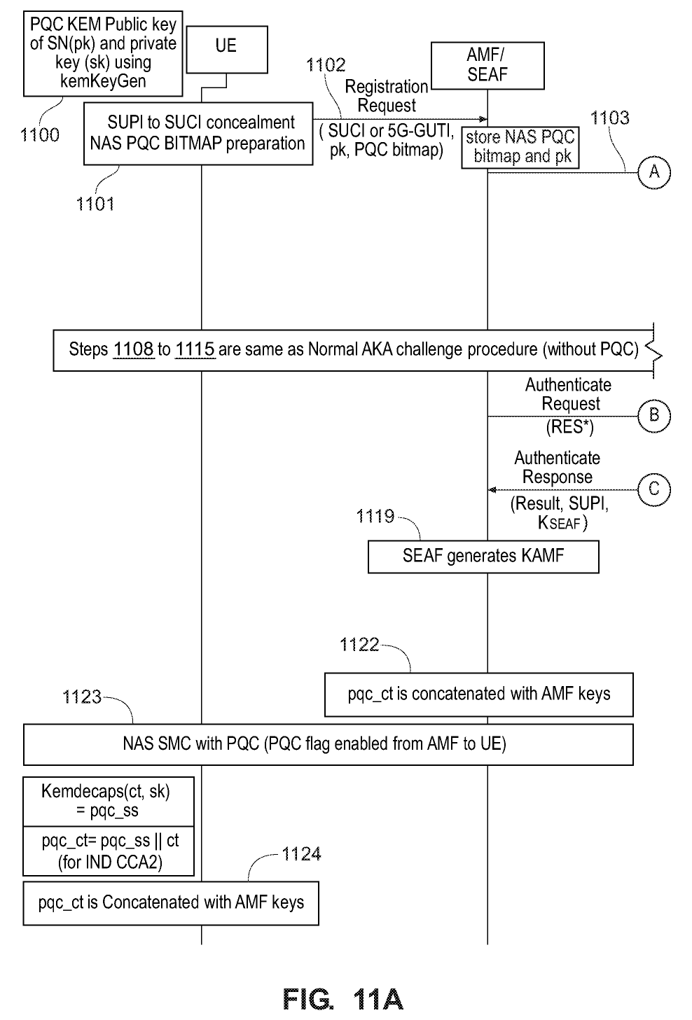

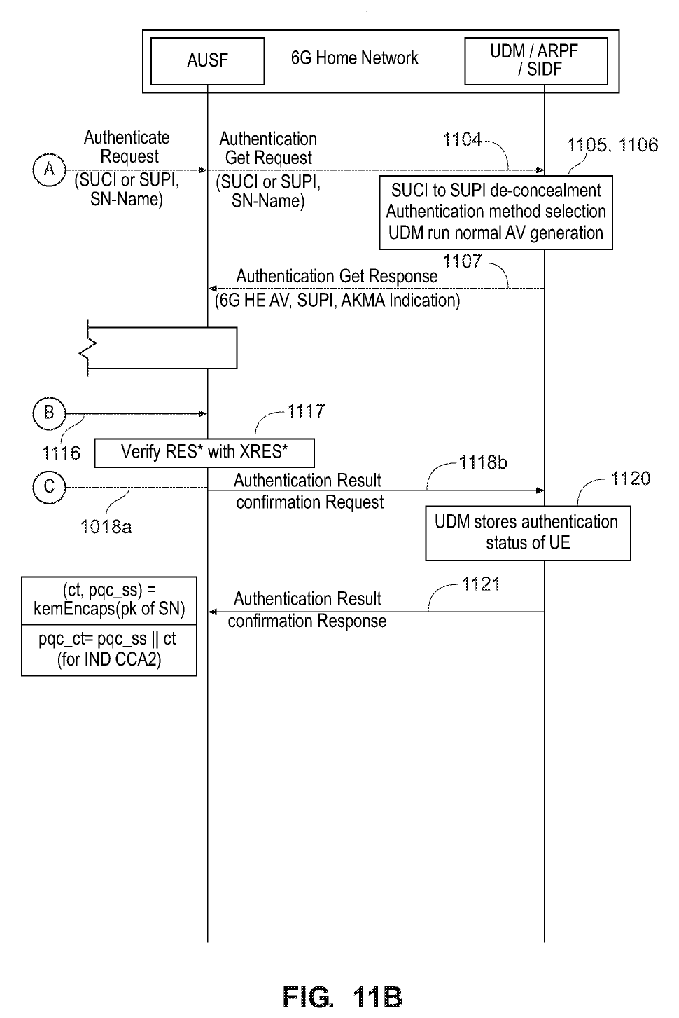

Now referring to FIGS. 11A-11B, there is described a fourth example that uses pure post-quantum cryptography (PQC), e.g., for 6G AKA procedures to further enhance quantum safety.

### UE initiating a registration procedure

At operation 1100, the UE generates a post quantum cryptography (PQC) KEM serving network public key SN(pk) and private key (sk) using a PQC kemkeyGen function.

At operation 1101, the UE performs SUPI to SUCI concealment and prepares a non-access stratum (NAS) PQC bitmap. An example PQC bitmap is shown at FIG. 13. In the example of FIG. 13, bits are set for the entities that support PQC. As shown, bits are set to “1” for 3GPP AN and serving network (SN), meaning the AN and SN support PQC; and bits are set to “0” for non 3GPP AN, SM NF, LMF NF, SMS NF and HN, meaning those entities do not support PQC. For those entities supporting PQC, AS SMC and NAS SMC will be run and the PQC shared keys are generated and concatenated with NAS and AS keys independently.

At operation 1102a, the UE transmits a Registration Request to the AMF. The Registration Request includes the SUCI or a 5G Global Unique Temporary Identifier (5G-GUTI), the PQC public key (pk) and the NAS PQC bitmap. At operation 1102b, the AMF stores the PQC public key (pk) and the NAS PQC bitmap.

At operation 1103, the SEAF sends an Authenticate Request to the AUSF to initiate an authentication. The Authenticate Request includes the SUCI or SUPI and the serving network name (SN-Name).

At operation 1104, if the serving network is authorized, the AUSF sends an Authentication Get Request to the UDM of the home network. The Authentication Get Request includes the SUCI or SUPI and the serving network name.

At operation 1105, the UDM invokes the SIDF if the SUCI is received, and performs SUCI to SUPI de-concealment. The UDM selects the authentication method (5G AKA, EAP-AKA' or EAP-TLS) for primary authentication based on the SUPI, and will give the inputs for invoking the authentication method to the AUSF.

### Home network computes a PQC AKA challenge

At operation 1106, the UDM performs a normal AV generation, such as described in relation to FIGS. 3A-3B, with the exception that it derives a 6G HE AV.

At operation 1107, the UDM sends an Authentication Get Response to the AUSF with the 6G HE AV, SUPI, an Authentication and Key Management for Application (AKMA) indication.

Operations 1108 to 1115 are not shown, inasmuch as they are the same as a normal AKA challenge procedure (without PQC), such as described in relation to FIGS. 3A-3B operations 308 to 315.

At operation 1116, the SEAF sends an Authenticate Request including RES* to the AUSF.

### UE authenticated by the home network

At operation 1117, the AUSF compares the received RES* with the stored XRES*. If the RES* and XRES* are equal, then AUSF considers the authentication successful from the home network point of view.

At operation 1118a, the AUSF sends an Authenticate Response to the SEAF to inform the SEAF of the authentication result. If the authentication was successful, the SUPI and the K_{SEAF} key is included in the Authenticate Response. At operation 1118b, the AUSF also informs the UDM about the authentication result (containing the SUPI, timestamp of authentication, authentication type and serving network name) in an Authentication Result confirmation Request message.

At operation 1119, the SEAF generates a K_{AMF} key with the received K_{SEAF}, IMSI and ABBA parameter. The SEAF shares the generated K_{AMF} and ngKSI with the AMF.

### Authentication results storage

At operation 1120, the UDM stores the authentication status of the UE.

At operation 1121, the UDM replies to the AUSF with the Authentication Result Confirmation Response message.

At operation 1122, the AMF uses a kemEncaps function with the public key (pk) to generate a shared secret (pqc_ss) and cipher text (ct). For IND_CCA2, the pqc_ss is concatenated with ct to form pqc_ct, and this value is concatenated with K_{AMF} to generate NAS keys, such as shown in FIG. 14. It is noted that the same procedure can be used for AS or RAN keys with PQC, for example, RAN key generation with PQC is shown at FIG. 15.

At operation 1123, the AMF sends a NAS SMC message to the UE with a PQC flag set. Therefore, the UE knows it is PQC SMC. The NAS SMC message includes ct.

At operation 1124, the USIM uses a Kemdecaps function using the ct and sk to generate the shared secret (pqc_ss). Then, as shown in FIG. 14, the pqc_ss is concatenated with ct to form pqc_ct, and this value (pqc_ct) is concatenated with an AMF non-PQC key (KAMF) to derive an AMF PQC key (KAMF_PQC).

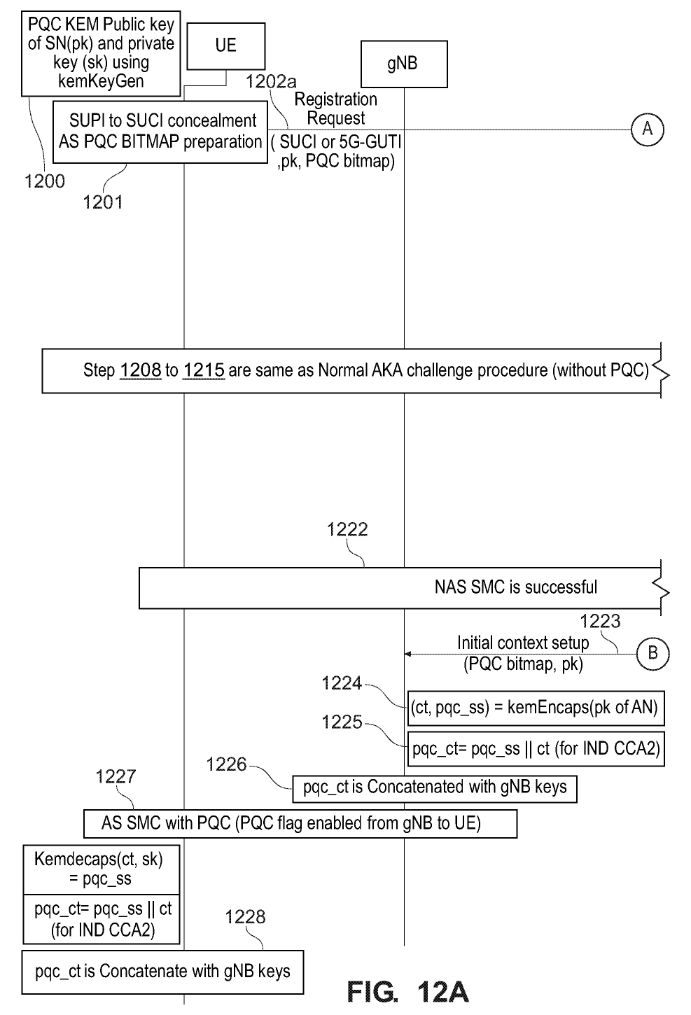

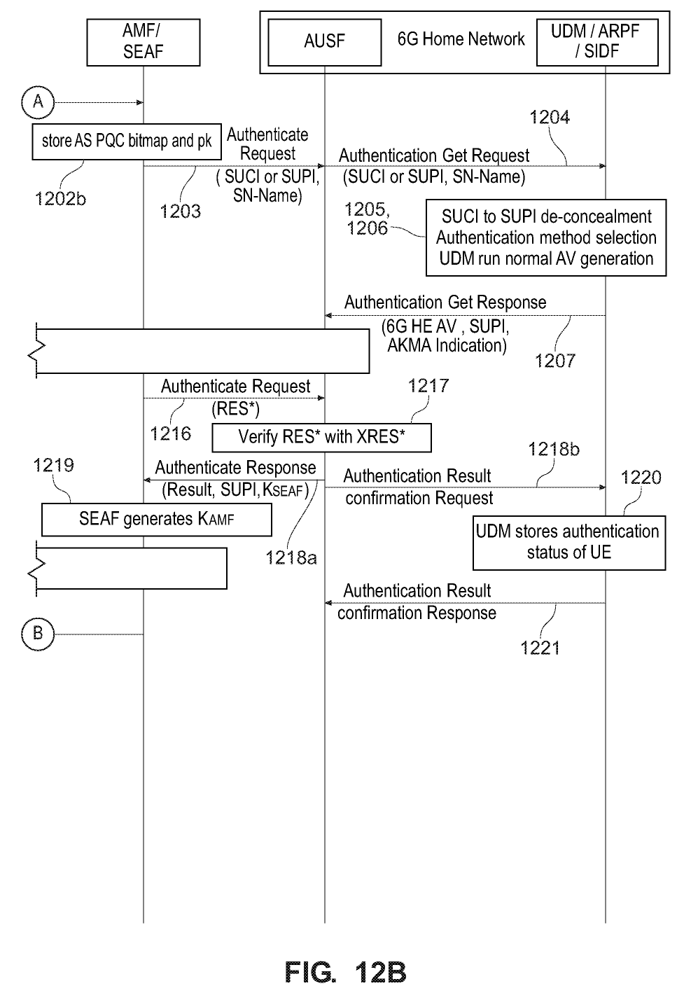

Now referring to FIGS. 12A-12B, there is described a fourth example that uses pure post-quantum cryptography (PQC), e.g., for 6G AKA procedures to further enhance quantum safety.

### UE initiating a registration procedure

At operation 1200, the UE generates a post quantum cryptography (PQC) KEM access network public key AN(pk) and private key (sk) using a PQC kemkeyGen function.

At operation 1201, the UE performs SUPI to SUCI concealment and prepares an access stratum (AS) PQC bitmap. An example PQC bitmap is shown at FIG. 13. In the example of FIG. 13, bits are set for the entities that support PQC. As shown, bits are set to “1” for 3GPP AN and serving network (SN), meaning the AN and SN support PQC; and bits are set to “0” for non 3GPP AN, SM NF, LMF NF, SMS NF and HN, meaning those entities do not support PQC. For those entities supporting PQC, AS SMC and NAS SMC will be run and the PQC shared keys are generated and concatenated with NAS and AS keys independently.

At operation 1202a, the UE transmits a Registration Request to the AMF. The Registration Request includes the SUCI or a 5G Global Unique Temporary Identifier (5G-GUTI), the PQC public key (pk) and the AS PQC bitmap. At operation 1202b, the AMF stores the PQC public key (pk) and the AS PQC bitmap.

At operation 1203, the SEAF sends an Authenticate Request to the AUSF to initiate an authentication. The Authenticate Request includes the SUCI or SUPI and the serving network name (SN-Name).

At operation 1204, if the serving network is authorized, the AUSF sends an Authentication Get Request to the UDM of the home network. The Authentication Get Request includes the SUCI or SUPI and the serving network name.

At operation 1205, the UDM invokes the SIDF if the SUCI is received, and performs SUCI to SUPI de-concealment. The UDM selects the authentication method (5G AKA, EAP-AKA' or EAP-TLS) for primary authentication based on the SUPI, and will give the inputs for invoking the authentication method to the AUSF.

### Home network computes a PQC AKA challenge

At operation 1206, the UDM performs a normal AV generation, such as described in relation to FIGS. 3A-3B, with the exception that it derives a 6G HE AV.

At operation 1207, the UDM sends an Authentication Get Response to the AUSF with the 6G HE AV, SUPI, an Authentication and Key Management for Application (AKMA) indication.

Operations 1208 to 1215 are not shown, inasmuch as they are the same as a normal AKA challenge procedure (without PQC), such as described in relation to FIGS. 3A-3B operations 308 to 315.

At operation 1216, the SEAF sends an Authenticate Request including RES* to the AUSF.

### UE authenticated by the home network

At operation 1217, the AUSF compares the received RES* with the stored XRES*. If the RES* and XRES* are equal, then AUSF considers the authentication successful from the home network point of view.

At operation 1218a, the AUSF sends an Authenticate Response to the SEAF to inform the SEAF of the authentication result. If the authentication was successful, the SUPI and the K_{SEAF} key is included in the Authenticate Response. At operation 1218b, the AUSF also informs the UDM about the authentication result (containing the SUPI, timestamp of authentication, authentication type and serving network name) in an Authentication Result confirmation Request message.

At operation 1219, the SEAF generates a K_{AMF} key with the received K_{SEAF}, IMSI and ABBA parameter. The SEAF shares the generated K_{AMF} and ngKSI with the AMF.

### Authentication results storage

At operation 1220, the UDM stores the authentication status of the UE.

At operation 1221, the UDM replies to the AUSF with the Authentication Result Confirmation Response message.

At operation 1222, NAS SMC authentication is successful.

At operation 1223, the AMF performs an initial context setup procedure with the gNB, in which the AMF sends the bitmap and pk to the gNB.

At operation 1224 and 1225, the gNB will generate the PQC shared key. Then at operation 1226, as shown in FIG. 15, the gNB key (K_{gNB}) is concatenated with the pqc_ct key to derive gNB PQC key (K_{gNB_PQC}) which is used to generate NAS encryption and integrity key.

At operation 1227, the gNB sends an access stratum (AS) security mode command (SMC) message to the UE with a PQC flag (i.e., PQC indication) set. Therefore, the UE knows it is PQC SMC. The AS SMC includes ct.

At operation 1228, the USIM uses a Kemdecaps function using the ct and sk to generate the shared secret (pqc_ss). Then, as shown in FIG. 15, the pqc_ss is concatenated with ct to form pqc_ct, and this value (pqc_ct) is concatenated with a gNB non-PQC key (KgNB) to derive a gNB PQC key (KgNB_PQC).

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

In various embodiments, the terms “first message” and “second message”, as well as any subsequent messages may refer to any messages that are transmitted or received in an order and are not necessarily limited to any particular message.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A user equipment, comprising:
at least one processor; and
at least one memory storing instructions that, when executed by the at least one processor, cause the user equipment to perform operations, the operations comprising:
obtaining a pre-shared post quantum key (PPK);
initiating a registration with a home network indicating use of the PPK;
receiving, from a network entity, an authentication challenge including an authentication token (AUTN PPK) and a PPK indication, wherein AUTN PPK is derived in part using the PPK; and
verifying the authentication token in part using the PPK.

2. The user equipment of claim 1, wherein AUTN PPK includes a message authentication code (MAC) derived in part using the PPK and the verifying the authentication token comprises:
obtaining the MAC from AUTN PPK;
computing an expected MAC (XMAC) based in part using the PPK; and
verifying the authentication token if XMAC equals MAC.

3. The user equipment of claim 1, wherein the operations further comprise:
computing an enhanced response (RES*) indicating successful verification, wherein RES* is derived in part using the PPK; and
send the enhanced response (RES*) to the network entity.

4. The user equipment of claim 3, wherein the computing the enhanced response (RES*) comprises:
computing a first response (RES) derived in part using the PPK;
computing the enhanced response (RES*) derived in part from RES.

5. A user equipment, comprising:
at least one processor; and
at least one memory storing instructions that, when executed by the at least one processor, cause the user equipment at least to:
obtaining a list of pre-shared post quantum keys (PPK);
initiating a registration with a home network indicating use of the PPK;
receiving, from a network entity, an authentication challenge including an authentication token (AUTN PPK) and a PPK indication identifying a selected PPK from the list of PPKs, wherein AUTN PPK is derived in part using the selected PPK; and
verifying the authentication token in part using the selected PPK.

6. The user equipment of claim 5, wherein AUTN PPK includes a message authentication code (MAC) derived in part using the selected PPK and the verifying the authentication token comprise:
obtaining the MAC from AUTN PPK;
computing an expected MAC (XMAC) based in part using the selected PPK; and
verifying the authentication token if XMAC equals MAC.

7. The user equipment of claim 6, wherein the operations further comprise:
computing an enhanced response (RES*) indicating successful verification, wherein RES* is derived in part using the selected PPK; and
sending the enhanced response (RES*) to the network entity.

8. The user equipment of claim 7, wherein the computing the enhanced response (RES*) comprises:
computing a first response (RES) derived in part using the selected PPK;
computing the enhanced response (RES*) derived in part from RES.

9. A user equipment, comprising:
at least one processor; and
at least one memory storing instructions that, when executed by the at least one processor, cause the user equipment at least to:
obtain a pre-shared post quantum key (PPK);
initiate a registration with a home network indicating use of the PPK;
receive, from a network entity, an authentication challenge including an authentication token (AUTN PPK) and a PPK indication;
verifying the authentication token;
compute an enhanced response (RES*) indicating successful verification, wherein RES* is derived in part using the PPK; and
sending the enhanced response (RES*) to the network entity.

10. The user equipment of claim 9, wherein AUTN PPK includes a message authentication code (MAC) derived in part using the PPK and the verifying the authentication token comprises:
obtaining the MAC from AUTN PPK;
computing an expected MAC (XMAC) based in part using the PPK; and
verifying the authentication token if XMAC equals MAC.

11. The user equipment of claim 10, wherein the operations further comprise:
compute an enhanced response (RES*) indicating successful verification, wherein RES* is derived in part using the PPK; and
send the enhanced response (RES*) to the network entity.

12. The user equipment of claim 11, wherein the computing the enhanced response (RES*) comprises:
computing a first response (RES) derived in part using the PPK;
computing the enhanced response (RES*) derived in part from RES.
